(19) United States
(12) Patent Application Publication
(10) Pub. No.: US 2005/0086234 A1
(43) Pub. Date: Apr. 21, 2005

(54) Incremental search of keyword strings

(75) Inventor: Joseph Peter Robert Tosey, N. Vancouver (CA)

Correspondence Address: Robert E. Krebs;Thelen Reid & Priest LLP, P.O. Box 640640, San Jose, CA, 95164-0640, US

(73) Assignee: Sierra Wireless, Inc., a Canadian Corporation

(21) Appl. No.: 10/687,218

(22) Filed: Oct. 15, 2003

(51) Int. Cl. G06F 17/00

(52) U.S. Cl. 707/100

(57) ABSTRACT

An incremental keyword search may be performed by receiving an input keyword string comprising one or more words having one or more symbols, creating a bit vector based at least in part on the input keyword string, comparing the bit vector with one or more other bit vectors representing at least one candidate keyword string to create a set of matching bit vectors and applying a conventional keyword matching algorithm to the at least one candidate keyword string represented by the matching bit vectors. Any matching candidate keyword strings are presented.

### FIELD OF THE INVENTION

The present invention relates to the field of computer science. More particularly, the present invention relates to a method and apparatus for incremental search of keyword strings.

### BACKGROUND OF THE INVENTION

Wireless user devices such as personal digital assistants (PDAs) and mobile phones typically include a small keyboard. The size of the keyboard makes using the keyboard difficult. For example, a PDA user desiring to find a movie entitled “Dances with Wolves” would have to enter several symbols to perform a search for information about the movie. Thus, it would be desirable to find the answer to such an input keyword string without having to type the entire search string.

Some solutions provide a real-time response to each input keyword string a user types. If the device can respond with the list of matches after each key is typed and as fast as the user can type, the user will know when to stop typing keys. As an example of a system that works this way, suppose a database contains numerous keyword strings, such as:
“Dances With Wolves”
“Jonathan Smith”
“Saint Louis”
“Sierra Wireless”.
   As the user types “w” in an input Window, the system instantly responds with keyword strings having at least one keyword that starts with the symbol “w”:
“Dances With Wolves”
“Sierra Wireless”.
   As the user continues to type “w d”, the system further narrows the response to keyword strings having at least one keyword that starts with the symbol “w” and at least one keyword that starts with the symbol “d”. In the above example, there is only one possible match: “Dances With Wolves”.

However, current real-time solutions have limitations that decrease the usefulness of the wireless user device. One “real-time” solution limits the size of the database searched to 10,000 entries (such as contacts on a device). Another “real-time” solution limits a keyword search to a single keyword in a keyword string.

Other solutions provide an exhaustive search capability of relatively large databases. However, these solutions not real-time, often taking several minutes to complete.

A need exists in the art for a system and method for real-time keyword string matching that enables a resource-constrained and CPU-constrained device such as a mobile phone, a PDA, or the like, find matches as fast as a user can type keys on the user device. A further need exists for such a solution that is relatively efficient. A further need exists for such a solution that allows more than one word in the keyword search string. Yet a further need exists for such a solution that is capable of searching a relatively large number of entries.

### SUMMARY OF THE INVENTION

An incremental keyword search may be performed by receiving an input keyword string comprising one or more words having one or more symbols, creating a bit vector based at least in part on the input keyword string, comparing the bit vector with one or more other bit vectors representing at least one candidate keyword string to create a set of matching bit vectors and applying a conventional keyword matching algorithm to the at least one candidate keyword string represented by the matching bit vectors. Any matching candidate keyword strings are presented.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a computer system suitable for implementing aspects of the present invention.

FIG. 2 is a block diagram of a wireless user device configured for incremental search of keyword strings in accordance with embodiments of the present invention.

FIG. 3 is a flow diagram that illustrates a method for creating a keyword string database in accordance with one embodiment of the present invention.

FIG. 4 is a flow diagram that illustrates a method for incremental search of keyword strings from the perspective of a user, in accordance with one embodiment of the present invention.

FIG. 5 is a flow diagram that illustrates a method for incremental keyword search from the perspective of a search engine, in accordance with one embodiment of the present invention.

FIG. 6A is a block diagram that illustrates creating a bit vector based on the input string “Dances With Wolves” in accordance with one embodiment of the present invention.

FIG. 6B is a block diagram that illustrates creating a bit vector based on the input string “Jonathan Smith” in accordance with one embodiment of the present invention.

FIG. 6C is a block diagram that illustrates creating a bit vector based on the input string “Saint Louis” in accordance with one embodiment of the present invention.

FIG. 6D is a block diagram that illustrates creating a bit vector based on the input string “Sierra Wireless” in accordance with one embodiment of the present invention.

FIG. 7 is a flow diagram that illustrates a method for creating a keyword string database comprising bit vectors having a bit position for each symbol in an alphabet and having bits set for bit positions corresponding to at least one symbol representing the first symbol of a word, in accordance with one embodiment of the present invention.

FIG. 8 is a flow diagram that illustrates a method for incremental search of keyword strings from the perspective of a user using the database of FIG. 7, in accordance with one embodiment of the present invention.

FIG. 9 is a flow diagram that illustrates a method for incremental search of keyword strings from the perspective of a search engine using the database of FIG. 7, in accordance with one embodiment of the present invention.

FIG. 10 is a block diagram that illustrates creating statistical groupings of one or more symbols based upon the relative frequency of use for each symbol.

FIG. 11 is a block diagram that illustrates creating a bit vector based on the first symbol of keywords in an input keyword string using the statistical groupings of FIG. 10 in accordance with one embodiment of the present invention.

FIG. 12 is a flow diagram that illustrates a method for comparing keyword strings based upon membership of the symbols in statistical groupings of symbols in accordance with one embodiment of the present invention.

FIG. 13 is a flow diagram that illustrates a method for creating a keyword string database comprising one or more summary bit vectors of candidate keyword strings in accordance with one embodiment of the present invention.

FIG. 14 is a flow diagram that illustrates a method for incremental search of keyword strings from the perspective of a user using the database of FIG. 13, in accordance with one embodiment of the present invention.

FIG. 15 is a flow diagram that illustrates a method for incremental search of keyword strings from the perspective of a search engine using the database of FIG. 13, in accordance with one embodiment of the present invention.

FIG. 16 is a block diagram that illustrates creating a summary bit vector based on the membership of the first symbols of the first word of a keyword string in a statistical grouping of symbols in accordance with one embodiment of the present invention.

FIG. 17 is a block diagram that illustrates creating a summary bit vector based on the membership of the first symbols of the first words of a keyword string in a statistical grouping of symbols in accordance with one embodiment of the present invention.

FIG. 18 is a flow diagram that illustrates a method for creating a keyword string database comprising one or more summary bit vectors where each bit corresponds to one or more symbols in an alphabet and where bits having a bit position corresponding to a symbol in a prefix of a word in a candidate keyword string are set, in accordance with one embodiment of the present invention.

FIG. 19 is a flow diagram that illustrates a method for incremental search of keyword strings from the perspective of a user using the database of FIG. 18, in accordance with one embodiment of the present invention.

FIG. 20 is a flow diagram that illustrates a method for incremental search of keyword strings from the perspective of a search engine using the database of FIG. 18, in accordance with one embodiment of the present invention.

FIG. 21 is a block diagram that illustrates assigning at least one bit of a summary bit vector to at least one non-alphabetical attribute associated with a keyword string in accordance with one embodiment of the present invention.

FIG. 22 is a block diagram that illustrates assigning at least one bit of a summary bit vector to at least one non-alphabetical attribute associated with a keyword string in accordance with one embodiment of the present invention.

FIG. 23A is a block diagram that illustrates the hierarchical organization of keyword strings in accordance with one embodiment of the present invention.

FIG. 23B is a block diagram that illustrates the hierarchical organization of keyword strings in accordance with one embodiment of the present invention.

FIG. 23C is a block diagram that illustrates the hierarchical organization of keyword strings in accordance with one embodiment of the present invention.

FIG. 24 is a flow diagram that illustrates a method for incremental search of hierarchically structured keyword strings in accordance with one embodiment of the present invention.

FIG. 25 is a flow diagram that illustrates a method for searching a hierarchy of bit vectors for a match with a pattern in accordance with one embodiment of the present invention.

### DETAILED DESCRIPTION

Embodiments of the present invention are described herein in the context of a method and apparatus incremental search of keyword strings. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In the context of the present invention, the term “network” includes local area networks, wide area networks, the Internet, cable television systems, telephone systems, wireless telecommunications systems, fiber optic networks, ATM networks, frame relay networks, satellite communications systems, and the like. Such networks are well known in the art and consequently are not further described here.

In the context of the present invention, the term “wireless user device” includes any device capable of wireless communication and capable of rendering information to a user. The information may be rendered, by way of example, by visual, auditory or tactile means. Exemplary wireless user devices include, by way of example, a personal digital assistant (PDA), a mobile phone, a personal computer, a pager, or the like.

In the context of the present invention, the term “alphabet” includes a set of letters or other symbols with which one or more languages are written.

In the context of the present invention, the term “symbol” includes an alpha-numeric character such as a number or a letter of an alphabet. More generally, the term “symbol” includes a sign used in writing or printing relating to a particular field to represent operations, quantities, elements, relations, or qualities.

In the context of the present invention, the term “conventional keyword matching algorithm” is defined as brute force matching algorithm, where a complete character string is compared directly with one or more other character strings.

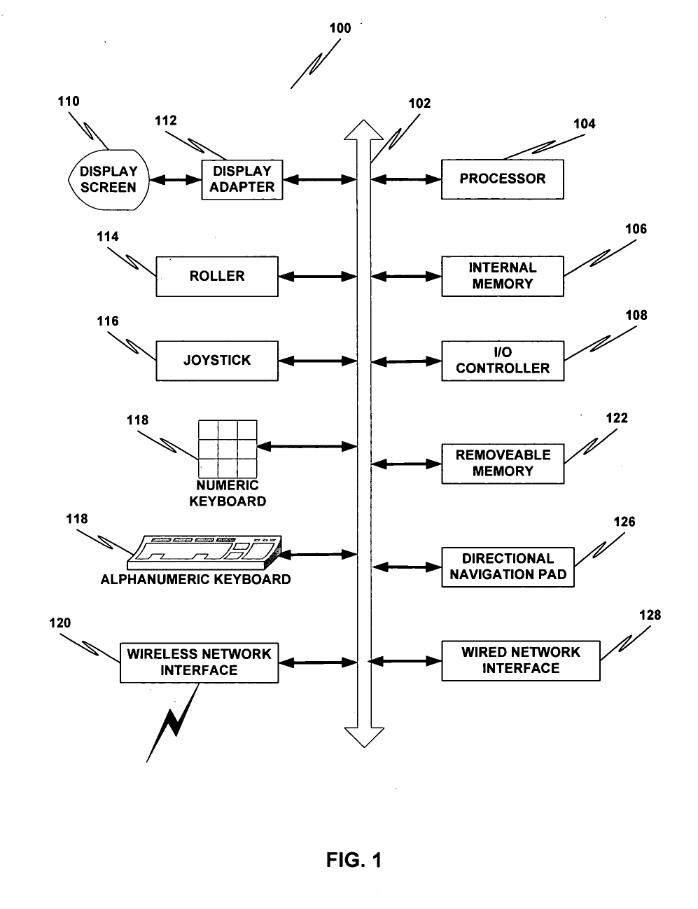

FIG. 1 depicts a block diagram of a computer system 100 suitable for implementing aspects of the present invention. As shown in FIG. 1, system 100 includes a bus 102 which interconnects major subsystems such as a processor 104, an internal memory 106 (such as a RAM), an input/output (I/O) controller 108, a removable memory (such as a memory card), an external device such as a display screen 110 via display adapter 112, a roller-type input device 114, a joystick 116, a numeric keyboard 118, an alphanumeric keyboard 118, directional navigation pad 126 and a wireless interface 120. Many other devices can be connected. Wireless network interface 120, wired network interface 128, or both, may be used to interface to a local or wide area network (such as the Internet) using any network interface system known to those skilled in the art.

Many other devices or subsystems (not shown) may be connected in a similar manner. Also, it is not necessary for all of the devices shown in FIG. 1 to be present to practice the present invention. Furthermore, the devices and subsystems may be interconnected in different ways from that shown in FIG. 1. Code to implement the present invention may be operably disposed in internal memory 106 or stored on storage media such as removeable memory 122, a floppy disk or a CD-ROM.

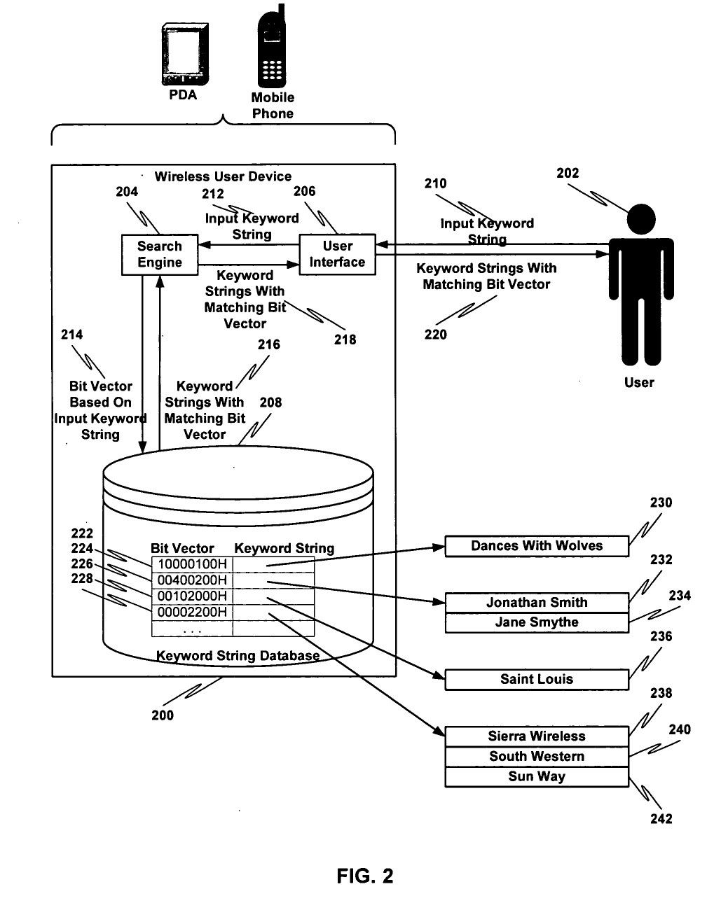

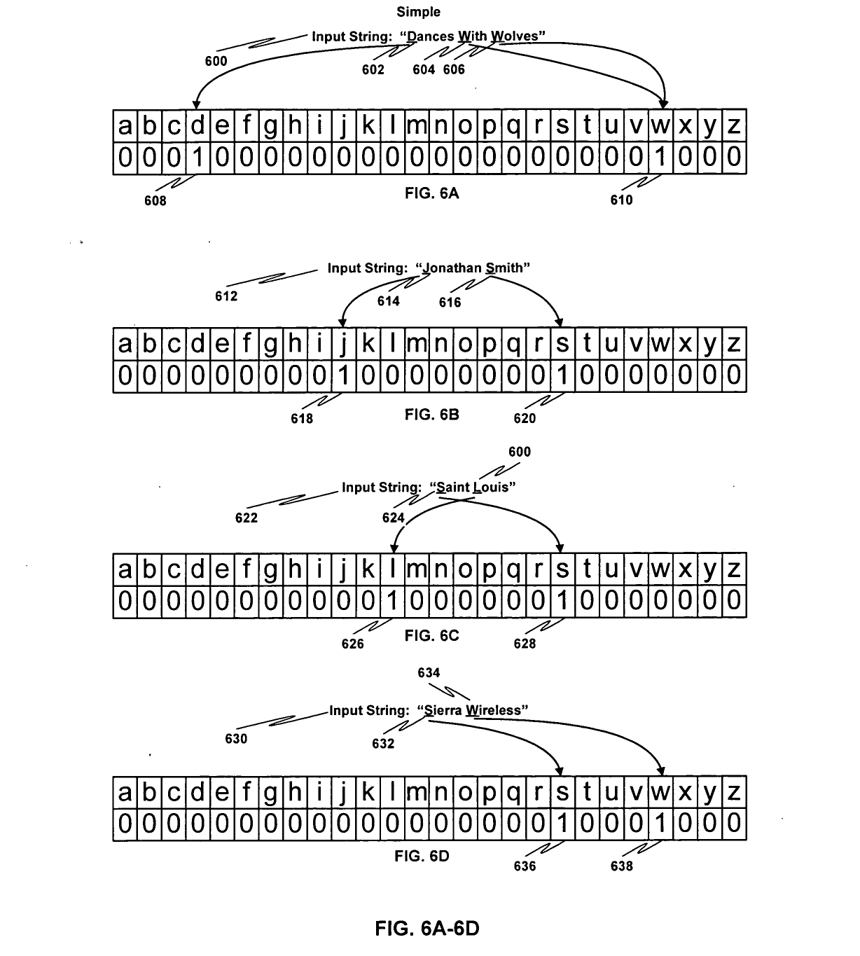

Turning now to FIG. 2, a block diagram of a wireless user device configured for incremental search of keyword strings in accordance with embodiments of the present invention is presented. Wireless user device 200 comprises a user interface 206 configured to accept an input keyword string 210 from a user 202 and to render to the user 202 one or more keyword strings having a matching bit vector 220. Wireless user device 200 also includes a searcher 204 configured to accept an input keyword string 212 user interface 206, obtain from keyword string database 208 one or more keyword strings with bit vectors matching a bit vector based on the input keyword string 214. Search engine 204 is also configured to communicate the matching keyword strings to user interface 206 for subsequent rendering to user 202. Keyword string database 208 comprises one or more entries comprising a bit vector and a reference to one or more keyword strings associated with the bit vector. As shown in FIG. 2, bit vectors 222-228 comprise 32-bit numbers, where each symbol of the English alphabet is assigned a particular bit position, and where bits in the bit vector that are set (have the value “1”) indicate that the first symbol of at least one word in a matching keyword string equals the symbol associated with the bit position. This particular bit vector mapping and other exemplary bit vector mappings are explained in more detail below with reference to FIGS. 6-9.

In operation, user 202 inputs a search string comprising one or more keywords comprising one or more symbols via user interface 206 of wireless user device 200. User interface 206 receives the input keyword string 210 and communicates it to search engine 204. Search engine 204 determines a bit vector of the input keyword string and communicates with keyword string database 208 to receive one or more keyword strings associated with a matching bit vector. Search engine 204 then communicates the one or more keyword strings to user interface 206, which displays the matching keyword strings to user 202.

According to one embodiment of the present invention, wireless user device 200 is configured to trigger a keyword string search each time user 202 enters a symbol of the input keyword string 210. The user 202 may continue entering symbols for the search, with each entry decreasing the number of matches.

Many other devices or subsystems (not shown) may be connected in manner similar to that shown in FIG. 2. Also, it is not necessary for all of the devices shown in FIG. 2 to be present to practice the present invention. Furthermore, the devices and subsystems may be interconnected in different ways from that shown in FIG. 2.

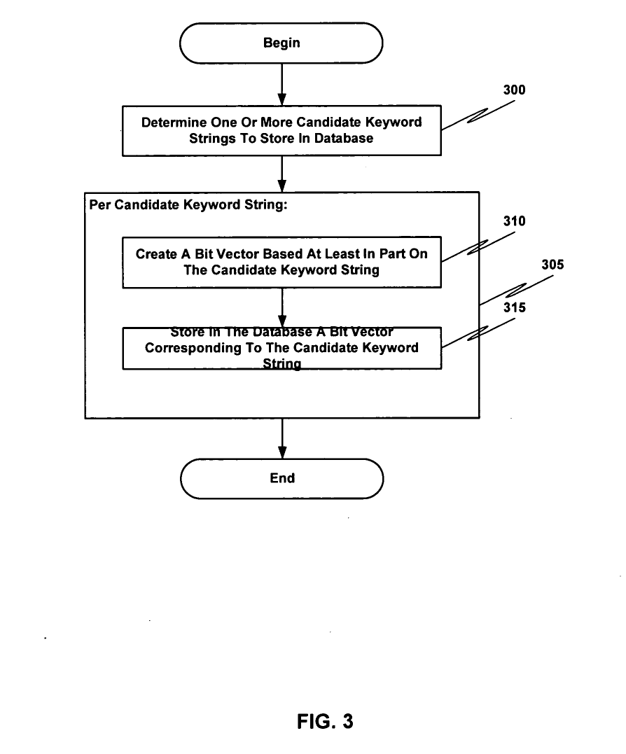

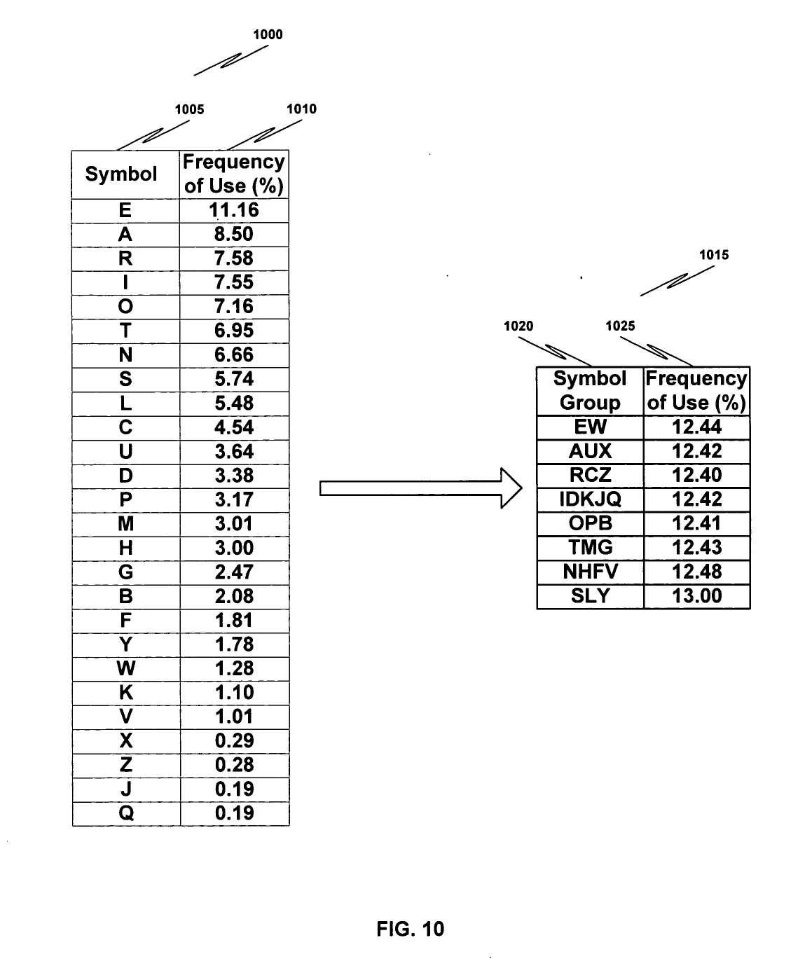

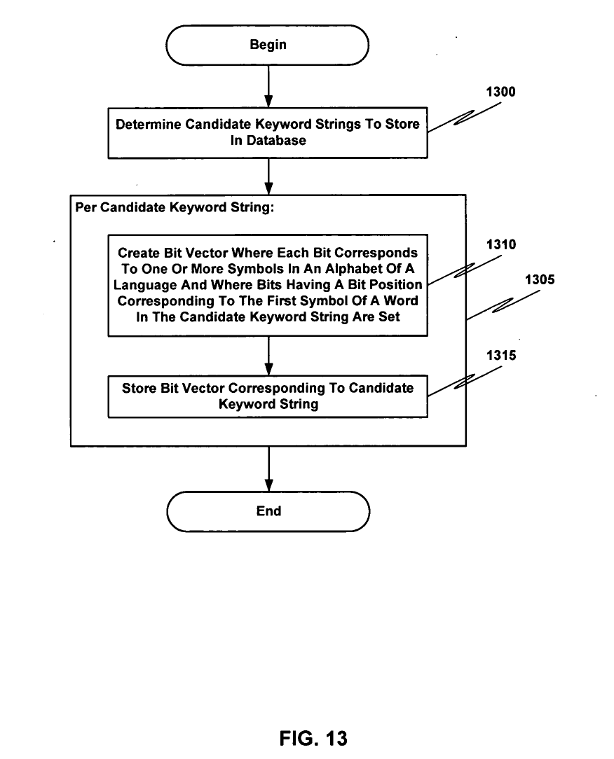

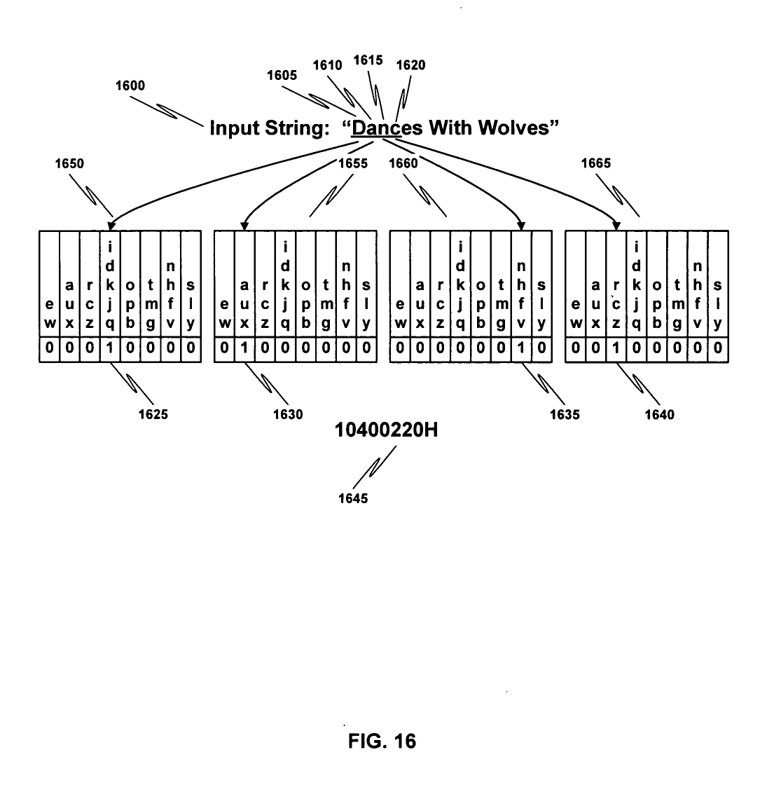

FIGS. 3-5 illustrate at a high level the creation and use of a keyword string database. FIGS. 6A-9 illustrate the creation and use of a keyword string database comprising bit vectors having a bit position for each symbol in an alphabet and having bits set for bit positions corresponding to at least one symbol representing the first symbol of a word. FIGS. 10-12 illustrate comparing keyword strings based upon membership of the symbols in statistical groupings of symbols. FIGS. 13-15 illustrate creating and using a keyword string database comprising one or more summary bit vectors of candidate keyword strings. FIGS. 16-20 illustrate creating and using a keyword string database comprising one or more summary bit vectors where each bit corresponds to one or more symbols in an alphabet and where bits having a bit position corresponding to a symbol in a prefix of a word in a candidate keyword string are set.

Turning now to FIG. 3, a flow diagram that illustrates a method for creating a keyword string database in accordance with one embodiment of the present invention is presented. At 300, one or more candidate keyword strings to store in the database are determined. The candidate keyword strings comprise the keyword strings against which all input keyword strings from a user are matched. Box 305 is repeated for each candidate keyword string determined at 300. At 310, a bit vector based at least in part on the candidate keyword string is created. At 315, a bit vector corresponding to the candidate keyword string is stored in the database.

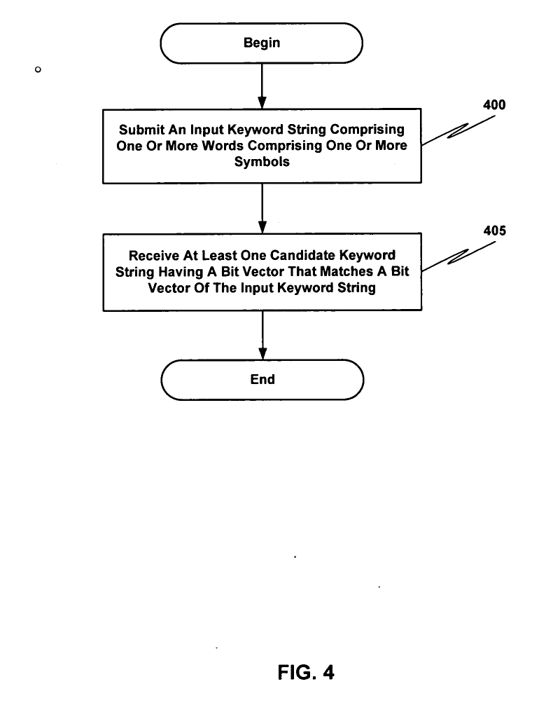

Turning now to FIG. 4, a flow diagram that illustrates a method for incremental search of keyword strings from the perspective of a user, in accordance with one embodiment of the present invention is presented. At 400, an input keyword string comprising one or more words comprising one or more symbols is submitted. If there are any matches, at 405 at least one candidate keyword string having a bit vector that matches a bit vector of the input keyword string is received. According to one embodiment of the present invention, processes 400 and 405 are performed each time a user enters a symbol of the input keyword string. The user may continue entering symbols for the search, with each entry decreasing the number of matches.

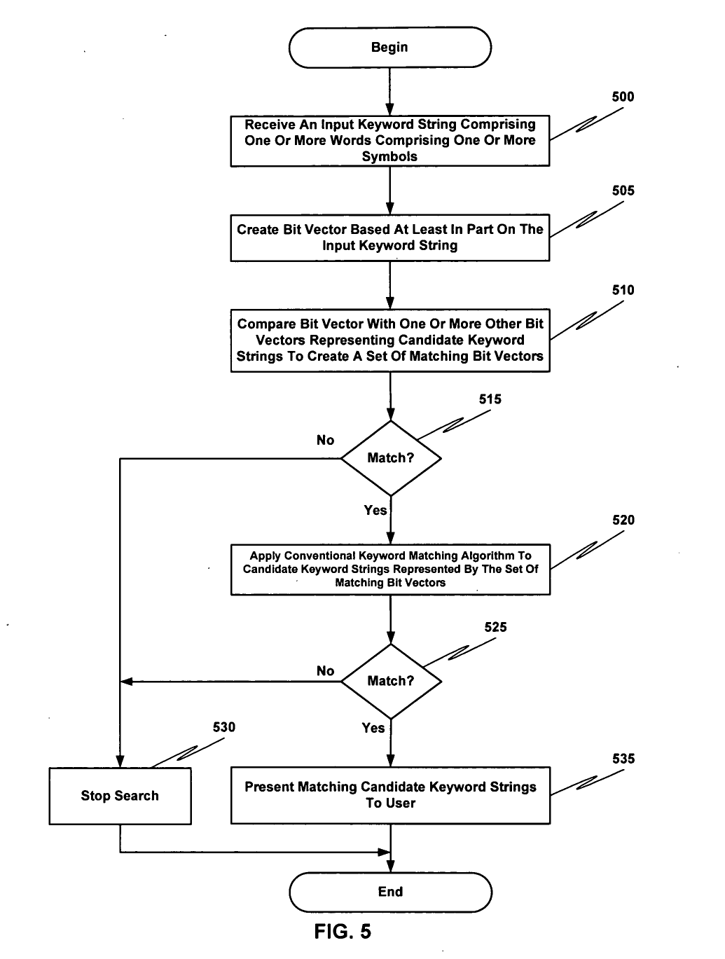

Turning now to FIG. 5, a flow diagram that illustrates a method for incremental keyword search from the perspective of a search engine, in accordance with one embodiment of the present invention is presented. At 500, an input keyword string comprising one or more words comprising one or more symbols is received. At 505, a bit vector based at least in part on the input keyword string is created. At 510, the bit vector is compared with one or more other bit vectors representing candidate keyword strings. According to one embodiment of the present invention, the bit vector comparison is independent of the order of keyword prefixes in keyword strings. By way of example, the input keyword string “J S” matches candidate keyword strings “John Smith” and “Sam Jones”. The result of step 510 is a set of matching bit vectors representing candidate keyword strings. At 515, a determination is made regarding whether there is a match. If there is a match, at 520 a conventional keyword matching algorithm is applied to candidate keyword strings represented by the set of matching bit vectors. At 525, a determination is made regarding whether the conventional keyword matching algorithm found a match. If there is a match, at 535 the matching candidate keyword strings are presented to the user. If there are no matches at 515 or 525, the search is halted at 530. Steps 505-515 reduce the number of times a conventional keyword matching algorithm must be applied (520), thus increasing the efficiency of a keyword string search.

FIGS. 6A-6D are block diagrams that illustrate creating a bit vector based on the first symbol of one or more words in an input keyword string in accordance with one embodiment of the present invention. FIG. 6A illustrates creating a bit vector based on the input string “Dances With Wolves” 600. The “D” in “Dances” (602) corresponds with bit 608. Both the “W” in “With” (604) and the “W” in “Wolves” (606) correspond to bit 610. Thus, the bit vector representing the input string “Dances With Wolves” 600 has bits 608 and 610 set.

FIG. 6B illustrates creating a bit vector based on the input string “Jonathan Smith” 612. The “J” in “Jonathan” (614) corresponds with bit 618 and the “S” in “Smith” (616) corresponds with bit 620. Thus, the bit vector representing the input string “Jonathan Smith” 612 has bits 618 and 620 set.

FIG. 6C illustrates creating a bit vector based on the input string “Saint Louis” 622. The “S” in “Saint” (624) corresponds with bit 628 and the “L” in “Louis” corresponds with bit 626. Thus, the bit vector representing the input string “Saint Louis” 622 has bits 626 and 628 set.

FIG. 6D illustrates creating a bit vector based on the input string “Sierra Wireless”. The “S” in “Sierra” (632) corresponds with bit 636 and the “W” in “Wireless” (634) corresponds with bit 638. Thus, the bit vector representing the input string “Sierra Wireless” (634) has bits 636 and 638 set.

As can be seen in FIGS. 6A-6D, bit vectors or masks in this embodiment are 26 bits long for the English language, ignoring numbers and upper case/lower case distinctions. These bit vectors can be represented within a 32 bit integer, thus allowing keyword string comparisons via a 32-bit integer comparison operation, such as:

| | |
|---|---|
| Int input_pattern | = 00010000000000000000001000B; |
| Int Dances_with_wolves | = 00010000000000000000001000B; |

If ((input_pattern & dances_with_wolves) == input_pattern)
{
// we have a potential match
}

As shown in the above example, evaluating the entire keyword string for a possible match required requires a relatively small number of machine instructions. Machine instruction time may be further optimized by placing keyword patterns in adjacent memory locations, thus avoiding pointer loads or page swapping.

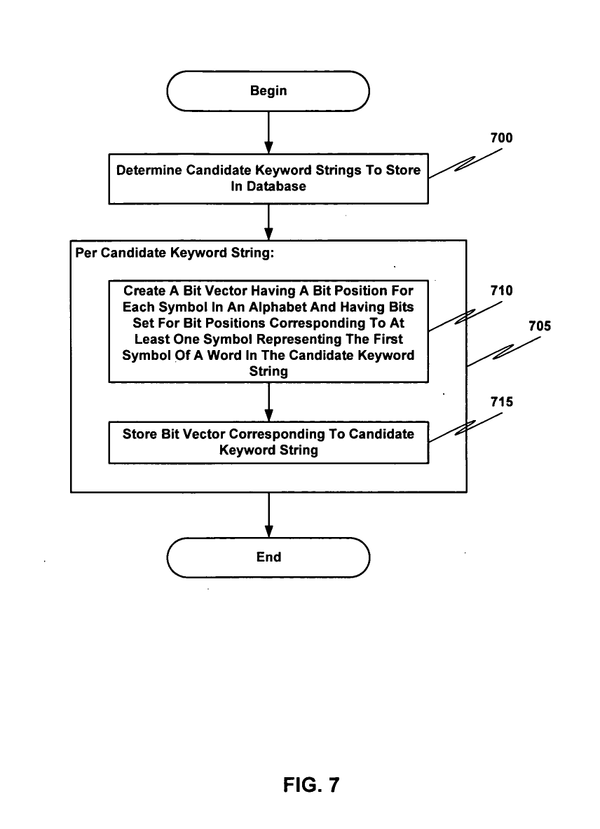

Turning now to FIG. 7, a flow diagram that illustrates a method for creating a keyword string database comprising bit vectors having a bit position for each symbol in an alphabet and having bits set for bit positions corresponding to at least one symbol representing the first symbol of a word, in accordance with one embodiment of the present invention is presented. At 700, candidate keyword strings to store in the database are determined. Box 705 is performed per candidate keyword string. At 710, a bit vector having a bit position for each symbol in an alphabet and having bits set for bit positions corresponding to at least one symbol representing the first symbol of a word is the candidate keyword string is created. At 715, the bit vector corresponding to the candidate keyword string is stored.

According to one embodiment of the present invention, the alphabet comprises the alphabet of the English language. Alphabets of any language may be used in accordance with embodiments of the present invention.

According to another embodiment, symbols that have both upper case forms share bit positions. According to another embodiment of the present invention, symbols having corresponding accented forms share the same bit postions. For example, the symbols “A”, “A”, “A” and “A” share the same bit position.

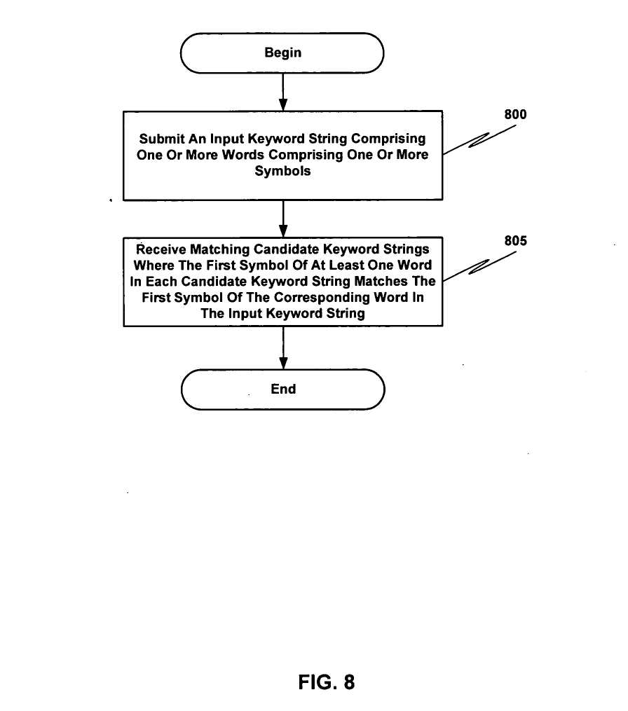

Turning now to FIG. 8, a flow diagram that illustrates a method for incremental search of keyword strings from the perspective of a user using the database of FIG. 7, in accordance with one embodiment of the present invention is presented. At 800, an input keyword string comprising one or more words comprising one or more symbols is submitted. If there are any matches, at 805 matching candidate keyword strings where the first symbol of at least one word in each candidate keyword string matches the first symbol of the corresponding word in the input keyword string are received. According to one embodiment of the present invention, processes 800 and 805 are performed each time a user enters a symbol of the input keyword string. The user may continue entering symbols for the search, with each entry decreasing the number of matches.

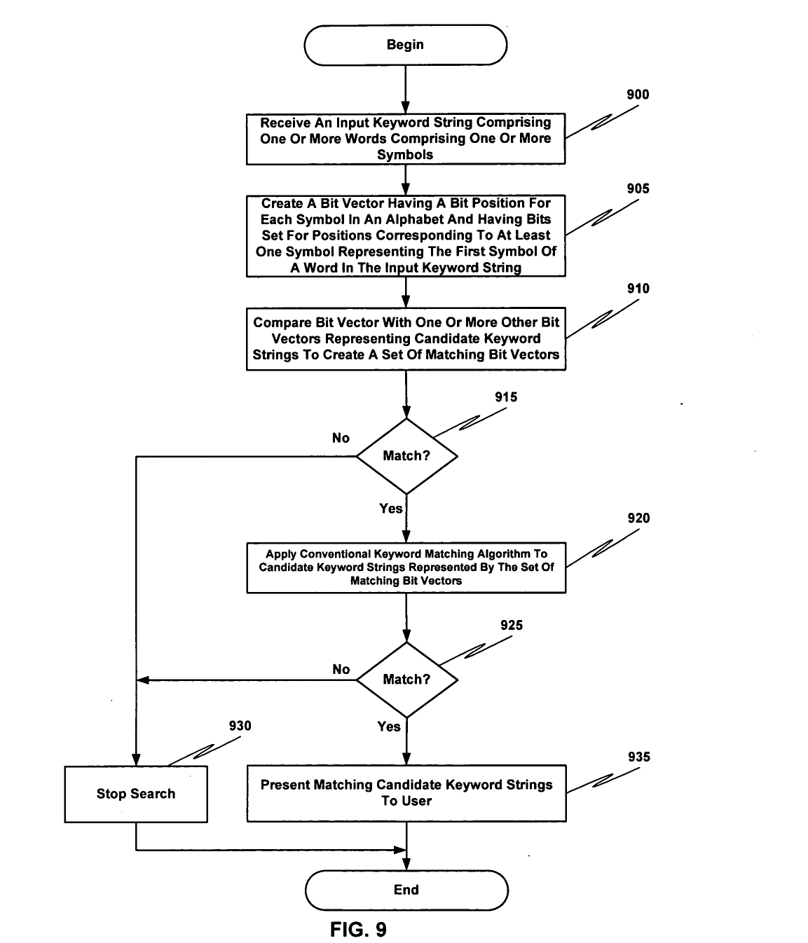

Turning now to FIG. 9, a flow diagram that illustrates a method for incremental search of keyword strings from the perspective of a search engine using the database of FIG. 7, in accordance with one embodiment of the present invention is presented. At 900, an input keyword string comprising one or more words comprising one or more symbols is received. At 905, a bit vector having a bit position for each symbol in an alphabet and having bits set for positions corresponding to at least one symbol representing the first symbol of a word in the input keyword string is created. At 910, the bit vector is compared with one or more other bit vectors representing candidate keyword strings. According to one embodiment of the present invention, the bit vector comparison is independent of the order of keyword prefixes in keyword strings. By way of example, the input keyword string “J S” matches candidate keyword strings “John Smith” and “Sam Jones”. The result of step 910 is a set of matching bit vectors representing candidate keyword strings. At 915, a determination is made regarding whether there is a match. If there is a match, at 920 a conventional keyword matching algorithm is applied to candidate keyword strings represented by the set of matching bit vectors. At 925, a determination is made regarding whether the conventional keyword matching algorithm found a match. If there is a match, at 935 the matching candidate keyword strings are presented to the user. If there are no matches at 915 or 925, the search is halted at 930. Steps 905-915 reduce the number of times a conventional keyword matching algorithm must be applied (920), thus increasing the efficiency of a keyword string search.

Turning now to FIG. 10, a block diagram that illustrates creating statistical groupings of one or more symbols based upon the relative frequency of use for each symbol. Table 1000 represents the results of a determination regarding the relative frequency of use for symbols in the English alphabet. Table 1015 shows the combination of symbols into symbol groups, with the frequency of use for each group equal to the sum of the frequencies of use for each member of the group. According to one embodiment of the present invention, the groupings are selected so as to minimize the differences between group frequencies of use.

The frequency table shown in FIG. 10 is for purposes of illustration and is not intended to be limiting in any way. According to embodiments of the present invention, a frequency table may be based on one or more utterances, such as an oral or written statement. Exemplary written statements include newspapers, novels, treatises, dictionaries and transcripts of oral utterances such as speeches. Those of ordinary skill in the art will recognize that other written statements may be used. The one or more utterances may be in any language, language dialect or slang. The one or more utterances may also be selected based at least in part on the speaker's demographics (such as age or income). The one or more utterances may also be based at least in part on a user's previous inputs to the wireless user device.

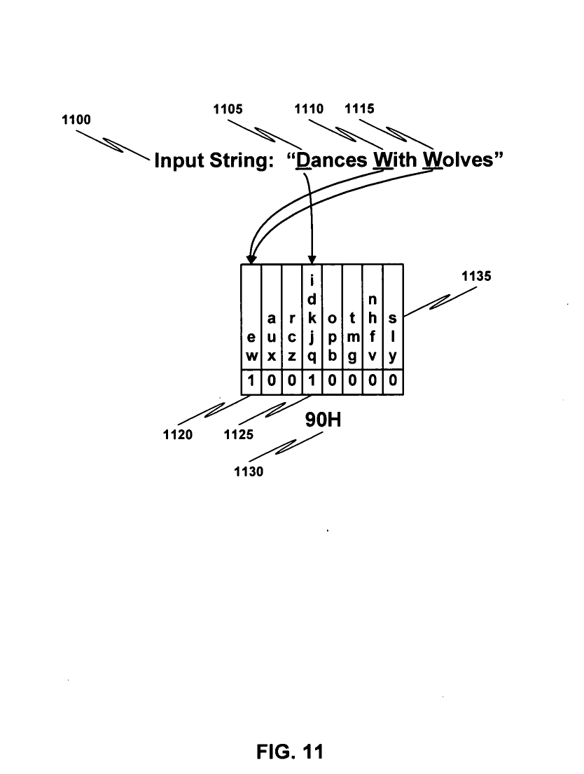

Turning now to FIG. 11, a block diagram that illustrates creating a bit vector based on the first symbol of keywords in an input keyword string using the statistical groupings of FIG. 10 in accordance with one embodiment of the present invention is presented. As shown in FIG. 11, a bit in bitmap 1135 is set if the bit position is associated with a symbol group that includes a symbol that matches the first symbol of a word in the input string 1100. The first symbol of each word in “Dances With Wolves” 1100 is “D” 1105, “W” 1110 and “W” 1115. The symbol “D” 1105 corresponds with bit position 1125 and the symbol “W” (1110, 1115) corresponds with the bit position 1120, so bits 1125 and 1120 are set.

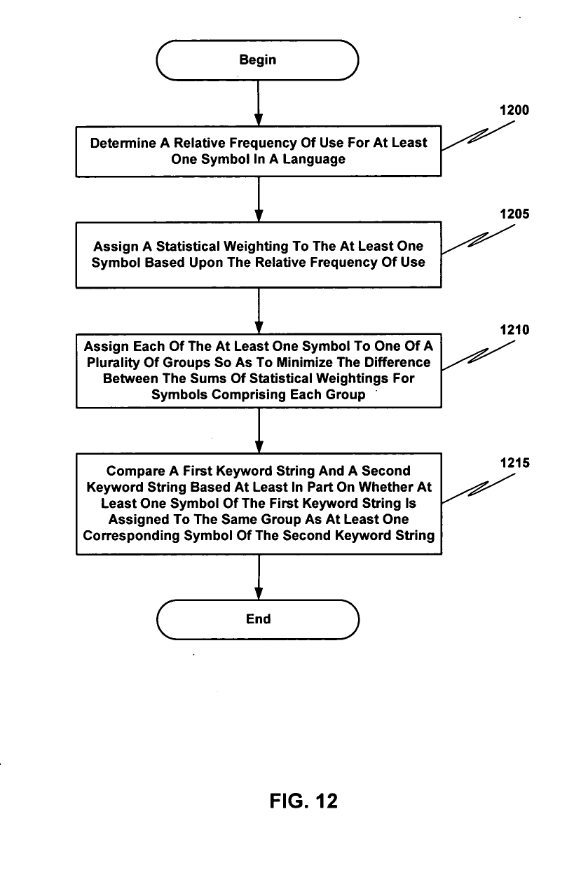

Turning now to FIG. 12, a flow diagram that illustrates a method for comparing keyword strings based upon membership of the symbols in statistical groupings of symbols in accordance with one embodiment of the present invention is presented. At 1200 a relative frequency of use for at least one symbol in a language is determined. According to one embodiment of the present invention, the relative frequency of use comprises the relative frequency of use of symbols in the first character of words in a language. At 1205 a statistical weighting is assigned to the at least one symbol based upon the relative frequency of use. At 1210 each of the at least one symbols is assigned to one of a plurality of groups so as to minimize the difference between sums of statistical weightings for symbols comprising each group. At 1215 a first keyword string and a second keyword string are compared based at least in part on whether at least one symbol of the first keyword string is assigned to the same group as at least one corresponding symbol of the second keyword string.

According to another embodiment of the present invention, keyword strings are compared based upon membership of the symbols in fixed groupings, or groupings that approximate the relative frequency of use of the symbols. By way of example, symbols may be grouped according to symbol grouping found on a standard telephone keyboard (“ABC”, “DEF”, “GHI”, “JKL”, “MNO”, “PQRS”, “TUV”, and “WXYZ”). Those of ordinary skill in the art will recognize other groupings are possible.

Turning now to FIG. 13, a flow diagram that illustrates a method for creating a keyword string database comprising one or more summary bit vectors of candidate keyword strings in accordance with one embodiment of the present invention is presented. At 1300, candidate keyword strings to store in a database are determined. Box 1305 is repeated per candidate keyword string. At 1310, a bit vector where each bit corresponds to one or more symbols in an alphabet of a language and where bits having a bit position corresponding to the first symbol of a word in the candidate keyword string are set. At 1315, the bit vector corresponding to the candidate keyword string is stored.

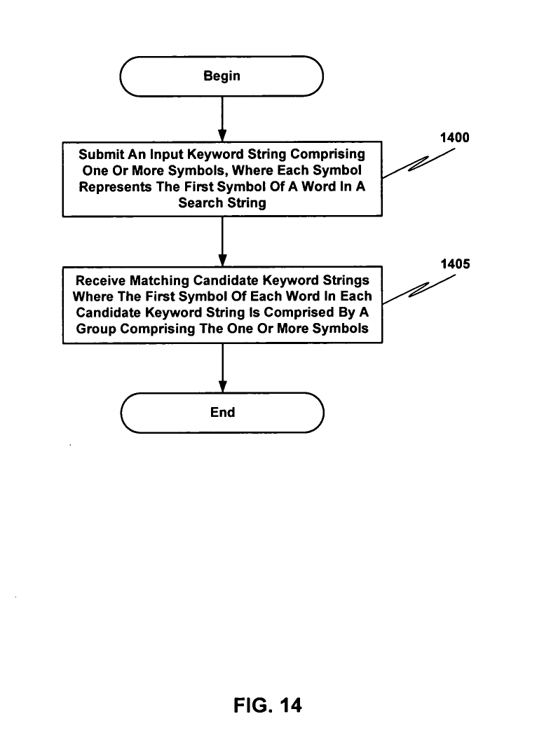

Turning now to FIG. 14, a flow diagram that illustrates a method for incremental search of keyword strings from the perspective of a user using the database of FIG. 13, in accordance with one embodiment of the present invention is presented. At 1400, an input keyword string comprising one or more symbols where each symbol represents the first symbol of a word in a search string is submitted. If there are any matches, at 1405 one or more matching candidate keyword strings where the first symbol of each candidate keyword string is comprised by a group comprising the one or more symbols is received. According to one embodiment of the present invention, processes 1400 and 1405 are performed each time a user enters a symbol of the input keyword string. The user may continue entering symbols for the search, with each entry decreasing the number of matches.

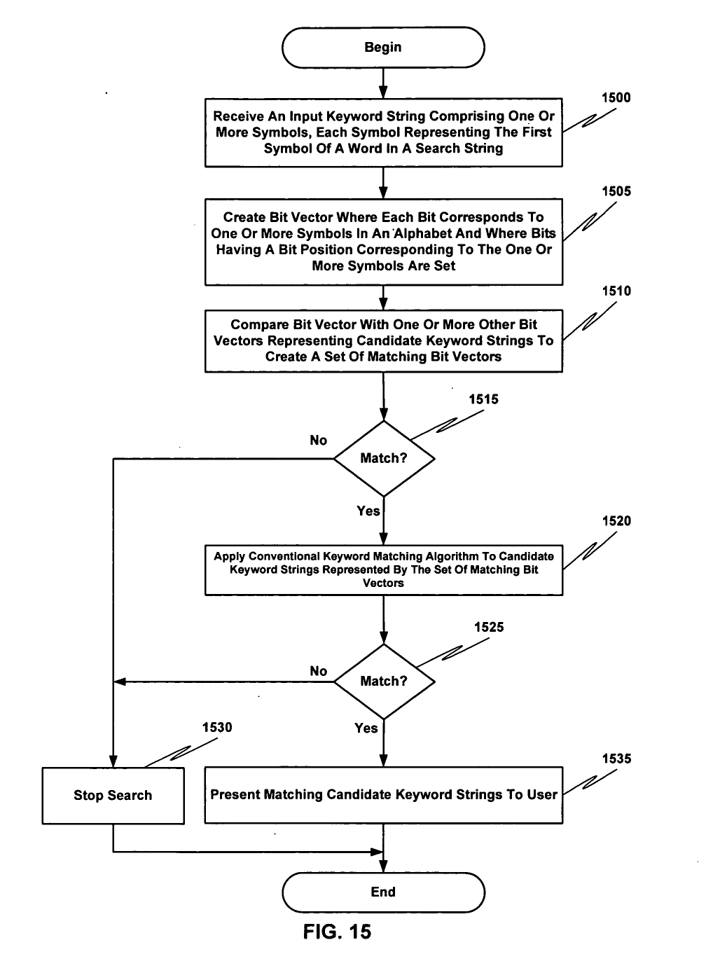

Turning now to FIG. 15, a flow diagram that illustrates a method for incremental search of keyword strings from the perspective of a search engine using the database of FIG. 13, in accordance with one embodiment of the present invention is presented. At 1500 an input keyword string comprising one or more symbols, where each symbol represents the first symbol of a word in a search string. At 1505 a bit vector where each bit corresponds to one or more symbols in an alphabet and where bits having a bit position corresponding to the one or more symbols are set. At 1510, the bit vector is compared with one or more other bit vectors representing candidate keyword strings. According to one embodiment of the present invention, the bit vector comparison is independent of the order of keyword prefixes in keyword strings. By way of example, the input keyword string “J S” matches candidate keyword strings “John Smith” and “Sam Jones”. The result of step 1510 is a set of matching bit vectors representing candidate keyword strings. At 1515, a determination is made regarding whether there is a match. If there is a match, at 1520 a conventional keyword matching algorithm is applied to candidate keyword strings represented by the set of matching bit vectors. At 1525, a determination is made regarding whether the conventional keyword matching algorithm found a match. If there is a match, at 1535 the matching candidate keyword strings are presented to the user. If there are no matches at 1515 or 1525, the search is halted at 1530. Steps 1505-1515 reduce the number of times a conventional keyword matching algorithm must be applied (1520), thus increasing the efficiency of a keyword string search.

Turning now to FIG. 16, a block diagram that illustrates creating a summary bit vector based on the membership of the first symbols of the first word of a keyword string in a statistical grouping of symbols in accordance with one embodiment of the present invention is presented. As shown in FIG. 16, the “D” in “Dances” (1605) corresponds with bit 1625 of bit vector 1650, the “a” in “Dances” (1610) corresponds with bit 1630 of bit vector 1655, the “n” in “Dances” (1615) corresponds with bit 1635 of bit vector 1660 and the “c” of “Dances” corresponds with bit 1640 of bit vector 1665. Combining the four eight-bit vectors results in the 32-bit hexadecimal value 10400220 (1645).

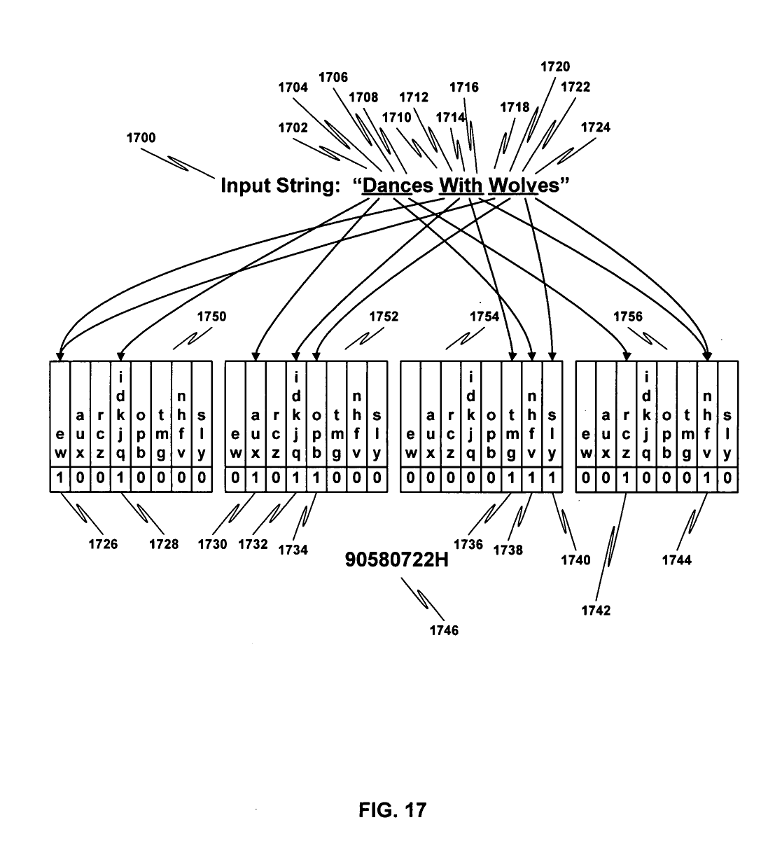

Turning now to FIG. 17, a block diagram that illustrates creating a summary bit vector based on the membership of the first symbols of the first words of a keyword string in a statistical grouping of symbols in accordance with one embodiment of the present invention is presented. FIG. 17 is similar to FIG. 16, except that the same four eight-bit vectors are used for the first four symbols of each word in the input string. As shown in FIG. 17, the symbols “D” (1702), “a” (1704), “n” (1706) and “c” (1708) in “Dances” correspond with bits 1728, 1730, 1738 and 1742, respectively. The symbols “W” (1710), “i” (1712), “t” (1714) and “h” (1716) in “With” correspond with bits 1726, 1732, 1736 and 1744, respectively. Likewise, the symbols “W” (1718), “o” (1720), “1” (1722) and “v” (1724) in “Wolves” correspond with bits 1726, 1734, 1740 and 1744, respectively. Combining the four eight-bit vectors results in the 32-bit hexadecimal value 90580722 (1746).

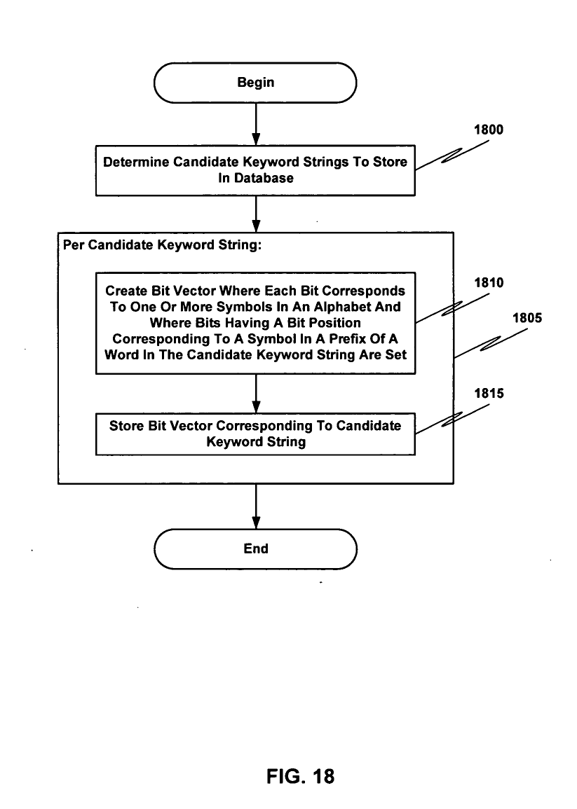

Turning now to FIG. 18, a flow diagram that illustrates a method for creating a keyword string database comprising one or more summary bit vectors where each bit corresponds to one or more symbols in an alphabet and where bits having a bit position corresponding to a symbol in a prefix of a word in a candidate keyword string are set, in accordance with one embodiment of the present invention is presented. At 1800, candidate keyword strings to store in a database are determined. Box 1805 is repeated per candidate keyword string. At 1810, a bit vector where each bit corresponds to one or more symbols in an alphabet and where bits having a bit position corresponding to a symbol in a prefix of a word in the candidate keyword string are set is created. At 1815, the bit vector corresponding to the candidate keyword string is stored.

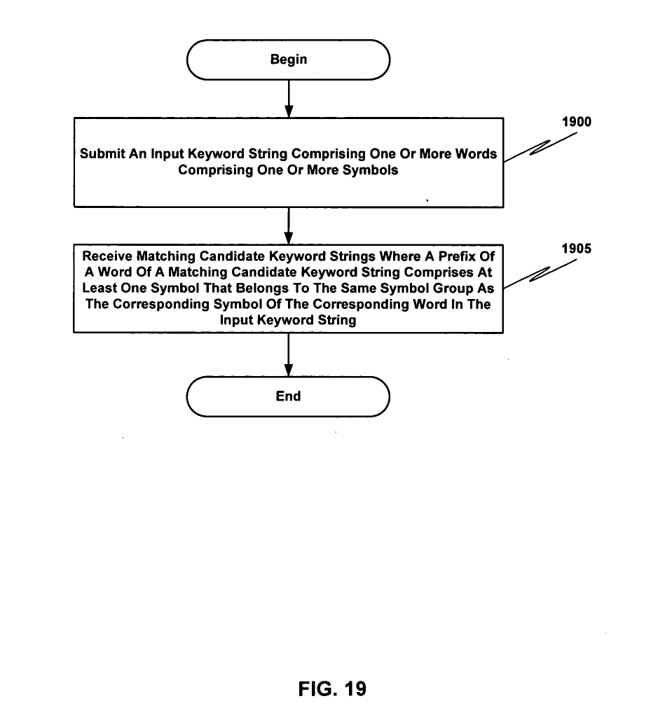

Turning now to FIG. 19, a flow diagram that illustrates a method for incremental search of keyword strings from the perspective of a user using the database of FIG. 18, in accordance with one embodiment of the present invention is presented. At 1900, an input keyword string comprising one or more words comprising one or more symbols is submitted. At 1905, one or more matching candidate keyword strings where a prefix of a word of a matching candidate keyword string comprises at least one symbol that belongs to the same symbol group as the corresponding symbol of the corresponding word in the input keyword string. According to one embodiment of the present invention, processes 1900 and 1905 are performed each time a user enters a symbol of the input keyword string. The user may continue entering symbols for the search, with each entry decreasing the number of matches.

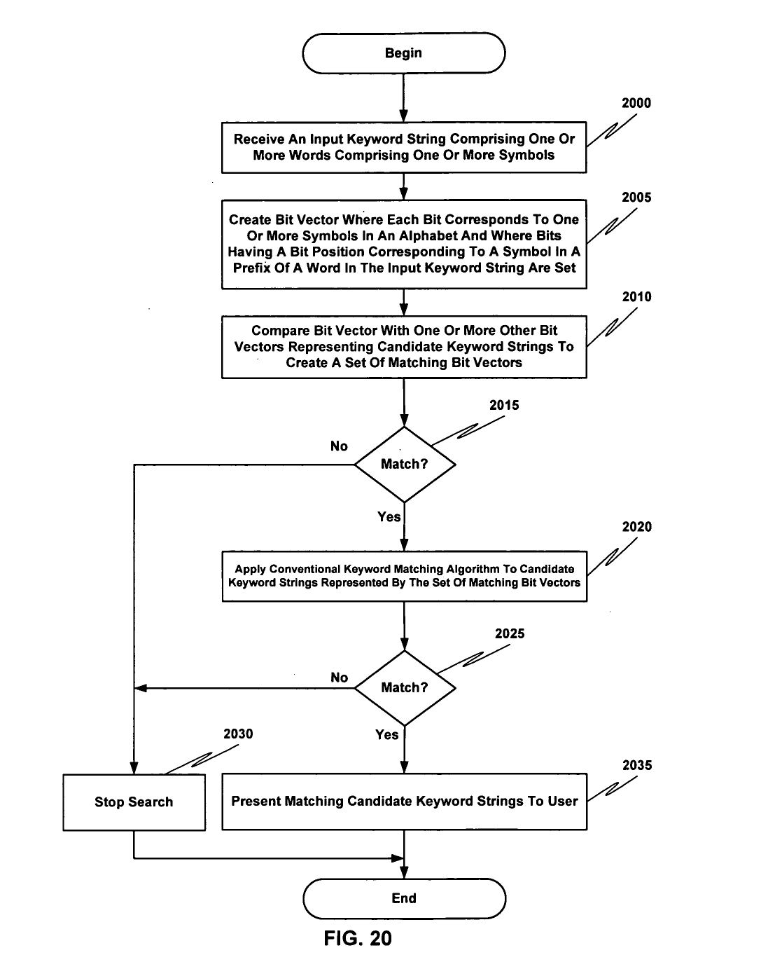

Turning now to FIG. 20, a flow diagram that illustrates a method for incremental search of keyword strings from the perspective of a search engine using the database of FIG. 18, in accordance with one embodiment of the present invention is presented. At 2000, an input keyword string comprising one or more words comprising one or more symbols is received. At 2005, a bit vector where each bit corresponds to one or more symbols in an alphabet and where bits having a bit position corresponding to a symbol in a prefix of a word in the candidate keyword string are set. At 2010, the bit vector is compared with one or more other bit vectors representing candidate keyword strings. According to one embodiment of the present invention, the bit vector comparison is independent of the order of keyword prefixes in keyword strings. By way of example, the input keyword string “J S” matches candidate keyword strings “John Smith” and “Sam Jones”. The result of step 2010 is a set of matching bit vectors representing candidate keyword strings. At 2015, a determination is made regarding whether there is a match. If there is a match, at 2020 a conventional keyword matching algorithm is applied to candidate keyword strings represented by the set of matching bit vectors. At 2025, a determination is made regarding whether the conventional keyword matching algorithm found a match. If there is a match, at 2035 the matching candidate keyword strings are presented to the user. If there are no matches at 2015 or 2025, the search is halted at 2030. Steps 2005-2015 reduce the number of times a conventional keyword matching algorithm must be applied (2020), thus increasing the efficiency of a keyword string search.

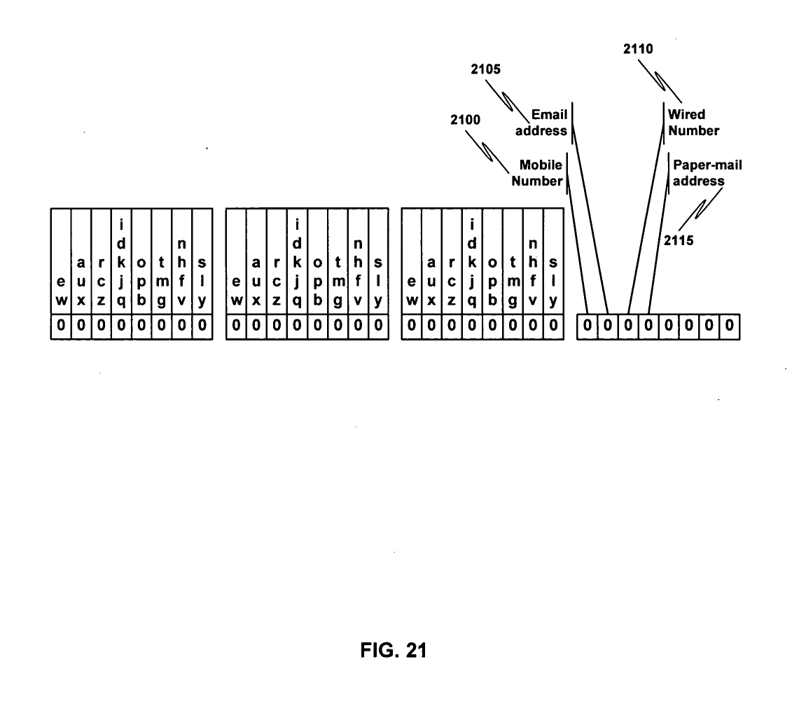

Turning now to FIG. 21, a block diagram that illustrates assigning at least one bit of a summary bit vector to at least one non-alphabetical attribute associated with a keyword string in accordance with one embodiment of the present invention is presented. Contacts in a database may have attributes such as a wired phone number (2110), mobile phone number (2100), email address (2105) and paper-mail address (2115). Those of ordinary skill in the art will appreciate that many other attributes may be stored in a similar fashion.

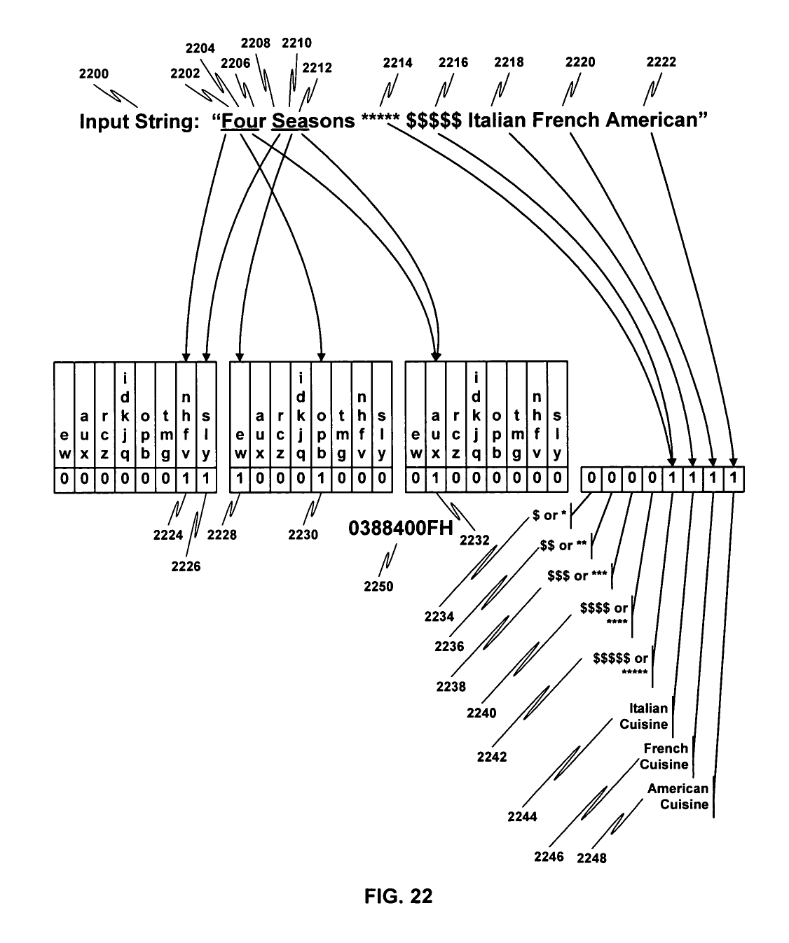

Services may have many non-alphabetical attributes that may be represented in a similar fashion. The cost of various hotels and restaurants may be rated by one to five dollar signs ($ to $$$$$). Additionally, the quality of hotels and restaurants may be rated by one to five stars (* to *****). As a further example, restaurants may be classified based on the type of cuisine (e.g. French, Italian, American). According to one embodiment of the present invention, non-alphabetical attributes are overloaded. According to another embodiment of the present invention, non-alphabetical attributes are overloaded in such a way as to statistically balance their usage, such as described above with respect to alphabetical attributes. According to another embodiment of the present invention, attributes having a strong correlation with each other are overloaded. By way of example if there is a strong correlation between the cost rating of a service and a quality rating of a service, the bits used to represent the attributes having a strong correlation are overloaded. This is illustrated below with reference to FIG. 22.

Turning now to FIG. 22, a block diagram that illustrates assigning at least one bit of a summary bit vector to at least one non-alphabetical attribute associated with a keyword string in accordance with one embodiment of the present invention is presented. As shown in FIG. 22, bits 2234-2242 are used for both a cost rating and a quality rating. For example, a cost rating of “$” is represented by setting the value of bit 2234 to “1”. A quality rating of “*” is represented by setting the same bit (2234) to the same value (1).

According to another embodiment of the present invention, a search algorithm as described herein is preempted if the search has not completed after a predetermined amount of time. According to one embodiment of the present invention, the predetermined amount of time is two seconds.

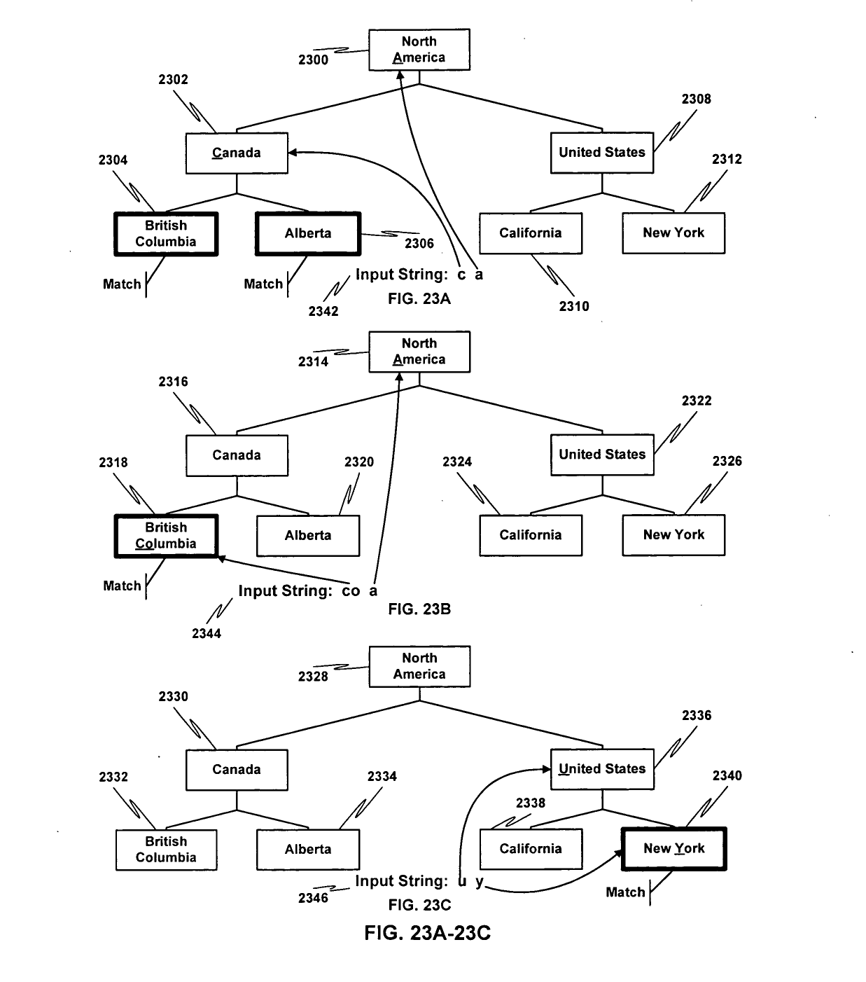

According to another embodiment of the present invention, keyword strings are organized hierarchically. An input keyword string is initially matched against keyword strings associated with the top of the hierarchy. If there is a match, the keyword that matched is removed from the input keyword string and the input keyword string is then matched against keyword strings associated with the part of the hierarchy associated with the keyword that matched. This process continues until there is no match or until the bottom of the hierarchy is reached. This is explained in more detail below with reference to FIGS. 23A-25.

FIGS. 23A-23B are block diagrams that illustrate the hierarchical organization of keyword strings in accordance with embodiments of the present invention. The hierarchies of FIGS. 23A-23C represent keyword strings for regions in North America. Referring to FIG. 23A, the highest level or top node 2300 represents North America. The lower level or child nodes of node 2300 represent two regions within North America: Canada 2302 and the United States 2308. Regions in Canada 2302 are represented by child nodes 2304 and 2306. Regions in the United States are represented by child nodes 2310 and 2312. According to embodiments of the present invention, an input keyword string matches a particular hierarchy element keyword string if each word of the input keyword string matches a prefix of a word in the hierarchy leading to the particular hierarchy element. Three examples are presented in FIGS. 23A-23C. As shown in FIG. 23A, a user may specify regions within Canada by entering the input keyword string “c a” 2342. The “a” in the keyword string 2342 matches the prefix “a” in “North America” 2300. The “c” in the keyword string 2342 matches the prefix “c” in “Canada”. Nodes 2304 and 2306 are child nodes of node 2302, so the keyword strings in the hierarchy of FIG. 23A that match the input string are “British Columbia” 2304 and “Alberta” 2306.

Referring to FIG. 23B, an input keyword string of “co a” 2344 matches “British Columbia” because the “a” of the input keyword string 2344 matches the prefix “A” in “North America” 2300 and the “co” of the input keyword string 2344 matches the prefix “Co” in “British Columbia”.

Referring to FIG. 23C, an input keyword string of “u y” 2346 matches “New York” because the “u” of the input keyword string matches the prefix “U” in “United States” and the “y” of the input keyword string 2346 matches the prefix “y” in “New York”.

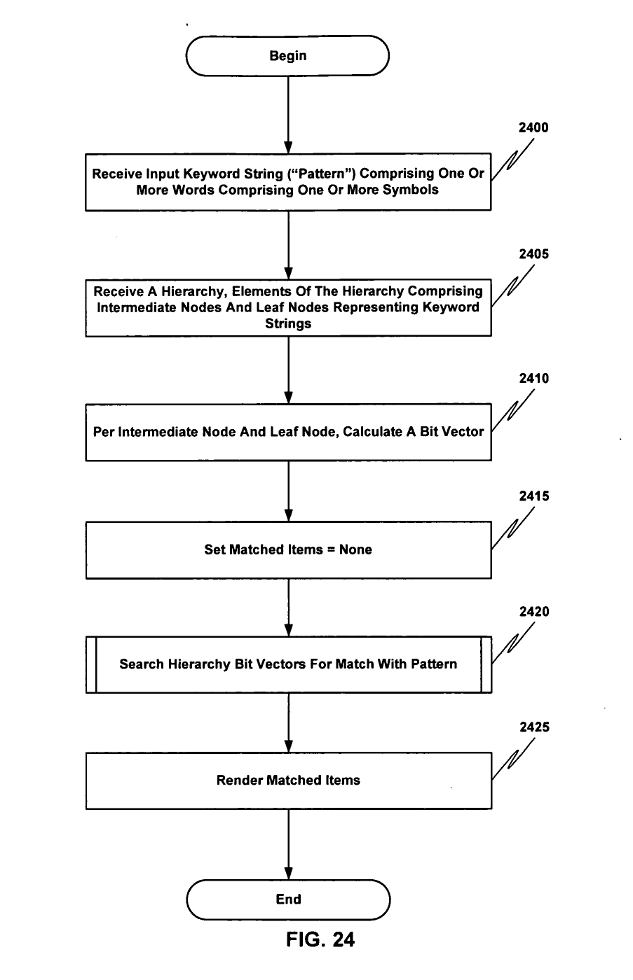

Turning now to FIG. 24, a flow diagram that illustrates a method for incremental search of hierarchically structured keyword strings in accordance with one embodiment of the present invention is presented. At 2400, an input keyword string or pattern comprising one or more keywords comprising one or more symbols is received. At 2405, a hierarchy is received. The elements of the hierarchy comprise intermediate nodes and leaf nodes representing keyword strings. At 2410, a bit vector is calculated for the keyword strings represented by each intermediate node and leaf node in the hierarchy. At 2415, a set of matched items is initialized to indicate there are no matched items. At 2402, the hierarchy of bit vectors created in process 2410 is searched for a match. At 2425, the matched items are output or rendered to a user.

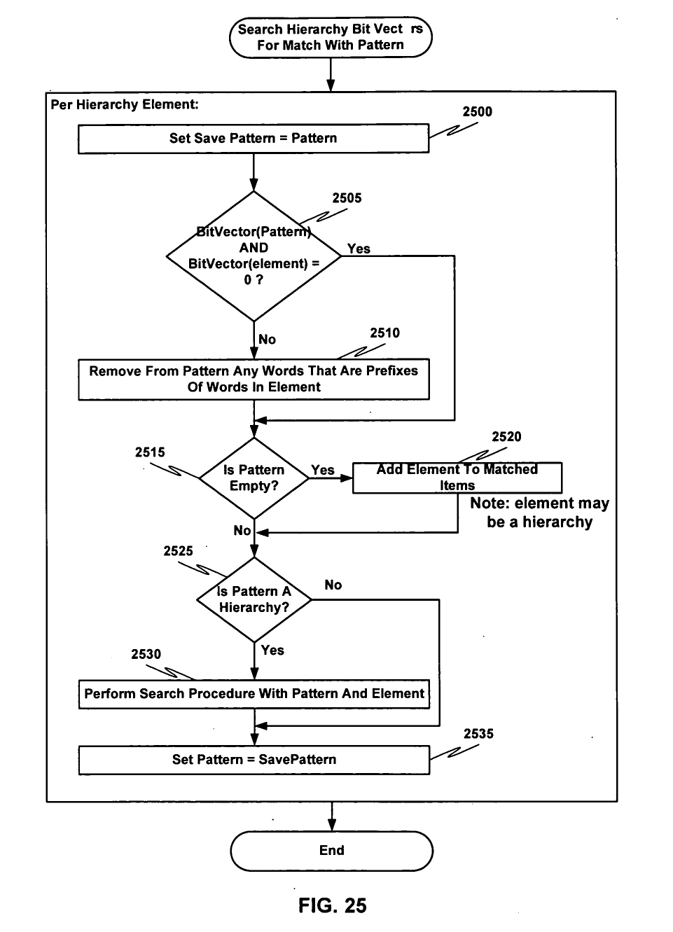

Turning now to FIG. 25, a flow diagram that illustrates a method for searching a hierarchy of bit vectors for a match with a pattern in accordance with one embodiment of the present invention is presented. FIG. 25 provides more detail for reference numeral 2420 of FIG. 24. The process illustrated by FIG. 25 is repeated per element in the hierarchy of bit vectors created in FIG. 24. At 2500, the input keyword string or pattern is saved. At 2505, a determination is made regarding whether the result of performing a logical “AND” operation on the pattern and the element is the value 0. If the answer is “No”, words of the pattern that are prefixes of words in the element are removed from the pattern. At 2515, a determination is made regarding whether the pattern is empty. If the pattern is empty, the element is added to the list of matched items at 2520. At 2525, a determination is made regarding whether the pattern is a hierarchy. If the pattern is a hierarchy, the search process illustrated in FIG. 25 is performed on the pattern and the element. At 2535, the saved input keyword string or pattern is restored.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for creating a keyword string database, the method comprising:
determining one or more candidate keyword strings to store in said database;
creating one or more bit vectors based at least in part on said one or more candidate keyword strings, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

2. The method of claim 1 wherein said bit vector further comprises at least one bit that represents a non-alphanumeric symbol.

3. The method of claim 2 wherein said non-alphanumeric symbol indicates an email address.

4. The method of claim 2 wherein said non-alphanumeric symbol indicates a mobile number.

5. The method of claim 2 wherein said non-alphanumeric symbol indicates a wired number.

6. The method of claim 2 wherein said non-alphanumeric symbol indicates a paper-mail address.

7. The method of claim 2 wherein said non-alphanumeric symbol indicates a cost ranking.

8. The method of claim 2 wherein said non-alphanumeric symbol indicates a quality ranking.

9. The method of claim 2 wherein said non-alphanumeric symbol indicates a cuisine.

10. A method for incremental keyword search, the method comprising:
submitting an input keyword string comprising one or more words comprising one or more symbols; and
receiving in response to said submitting at least one candidate keyword string having a bit vector that matches a bit vector of said input keyword string.

11. The method of claim 10, further comprising preempting said method after a predetermined amount of time.

12. The method of claim 11 wherein said predetermined amount of time is two seconds.

13. A method for incremental keyword search, the method comprising:
receiving an input keyword string comprising one or more words comprising one or more symbols;
creating a bit vector based at least in part on said input keyword string;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

14. The method of claim 13, further comprising preempting said method after a predetermined amount of time.

15. The method of claim 14 wherein said predetermined amount of time is two seconds.

16. The method of claim 13 wherein said comparing is independent of the order of keyword prefixes in keyword strings.

17. A method for creating a keyword string database, the method comprising:
determining one or more candidate keyword strings to store in said database;
creating one or more bit vectors based at least in part on said one or more candidate keyword strings, said bit vector having a bit position for each symbol in an alphabet and having bits set for bit positions corresponding to at least one symbol representing the first symbol of a word in said one or more candidate keyword strings, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

18. A method for incremental keyword search, the method comprising:
submitting an input keyword string comprising one or more words comprising one or more symbols; and
receiving in response to said submitting at least one candidate keyword string where the first symbol of at least one word in each of said at least one candidate keyword string matches the first symbol of the corresponding word in said input keyword string.

19. The method of claim 18, further comprising preempting said method after a predetermined amount of time.

20. The method of claim 19 wherein said predetermined amount of time is two seconds.

21. A method for incremental keyword search, the method comprising:
receiving an input keyword string comprising one or more words comprising one or more symbols;
creating a bit vector based at least in part on said input keyword string, said bit vector having a bit position for each symbol in an alphabet and having bits set for positions corresponding to at least one symbol representing the first symbol of a word in said input keyword string;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

22. The method of claim 21, further comprising preempting said method after a predetermined amount of time.

23. The method of claim 22 wherein said predetermined amount of time is two seconds.

24. The method of claim 21 wherein said comparing is independent of the order of keyword prefixes in keyword strings.

25. A method for comparing keyword strings, the method comprising:
determining a relative frequency of use for at least one symbol in a language;
assigning a statistical weighting to said at least one symbol based at least in part on a relative frequency of use of said at least one symbol;
assigning each of said at least one symbol to one of a plurality of groups; and
comparing a first keyword string and a second keyword string based at least in part on whether at least one symbol of said first keyword string is assigned to the same group as at least one corresponding symbol of said second keyword string.

26. The method of claim 25 wherein said assigning further comprises assigning each of said at least one symbol to one of a plurality of groups so as to minimize the difference between the sums of statistical weightings for symbols comprising each group in said plurality of groups.

27. The method of claim 25 wherein said relative frequency of use comprises the relative frequency of use of symbols in the first character of words in said language.

28. A method for creating a keyword string database, the method comprising:
determining one or more candidate keyword strings to store in said database;
creating one or more bit vectors based at least in part on said one or more candidate keyword strings, each bit of said one or more bit vectors corresponding to one or more symbols in an alphabet, bits having a bit position corresponding to the first symbol of a word in said one or more candidate keyword strings being set, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

29. A method for incremental keyword search, the method comprising:
submitting an input keyword string comprising one or more words comprising one or more symbols, each symbol representing the first symbol of a word in a search string; and
receiving in response to said submitting at least one candidate keyword string where the first symbol of each word in each candidate keyword string is comprised by a group comprising said one or more symbols.

30. The method of claim 29, further comprising preempting said method after a predetermined amount of time.

31. The method of claim 30 wherein said predetermined amount of time is two seconds.

32. A method for incremental keyword search, the method comprising:
receiving an input keyword string comprising one or more words comprising one or more symbols, each symbol representing the first symbol of a word in a search string;
creating a bit vector based at least in part on said input keyword string, each bit corresponding to one or more symbols in an alphabet, bits having a bit position corresponding to said one or more symbols being set;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

33. The method of claim 32, further comprising preempting said method after a predetermined amount of time.

34. The method of claim 33 wherein said predetermined amount of time is two seconds.

35. The method of claim 32 wherein said comparing is independent of the order of keyword prefixes in keyword strings.

36. A method for creating a keyword string database, the method comprising:
determining one or more candidate keyword strings to store in said database;
creating one or more bit vectors based at least in part on said one or more candidate keyword strings, each bit of said one or bit vector corresponding to one or more symbols in an alphabet, bits having a bit position corresponding to a symbol of a prefix of a word in said one or more candidate keyword strings being set, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

37. A method for incremental keyword search, the method comprising:
submitting an input keyword string comprising one or more words comprising one or more symbols; and
receiving in response to said submitting at least one candidate keyword string where a prefix of a word of a matching candidate keyword string comprises at least one symbol that belongs to the same symbol group as the corresponding symbol of the corresponding word in said input keyword string.

38. The method of claim 37, further comprising preempting said method after a predetermined amount of time.

39. The method of claim 38 wherein said predetermined amount of time is two seconds.

40. A method for incremental keyword search, the method comprising:
receiving an input keyword string comprising one or more words comprising one or more symbols;
creating a bit vector based at least in part on said input keyword string, each bit corresponding to one or more symbols in an alphabet, bits having a bit position corresponding to a prefix of a word in said one or more symbols being set;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

41. The method of claim 40, further comprising preempting said method after a predetermined amount of time.

42. The method of claim 41 wherein said predetermined amount of time is two seconds.

43. The method of claim 40 wherein said comparing is independent of the order of keyword prefixes in keyword strings.

44. A method for incremental keyword search, the method comprising:
receiving an input keyword string comprising one or more words comprising one or more symbols, each symbol representing the first symbol of a word in a search string;
receiving a hierarchy, elements of said hierarchy comprising intermediate nodes and leaf nodes representing one or more keyword strings comprising one or more words comprising one or more symbols;
creating hierarchy bit vectors corresponding to said one or more keyword strings in said hierarchy;
searching said hierarchy bit vectors for a match with said input keyword string, said searching comprising, for each of said elements of said hierarchy:
saving said input keyword string;
applying a logical “AND” operation to the bit vector of the element and a bit vector based at least in part on said input keyword string, said applying producing a result;
if said result is nonzero, removing from said input keyword string any words in said input keyword string that are prefixes of words in the element;
if said input keyword string is empty, adding said element to a list of matched items; and
restoring said input keyword string; and
rendering said list of matched items.

45. A method for creating a keyword string database, the method comprising:
step for determining one or more candidate keyword strings to store in said database;
step for creating one or more bit vectors based at least in part on said one or more candidate keyword strings, said one or more bit vectors for use in comparing an input bit vector with said one or more bit vectors to indicate whether an input keyword string represented by said input bit vector matches said one or more candidate keyword strings; and
step for storing said one or more bit vectors and a reference to said one or more candidate keyword strings in said database.

46. The method of claim 45 wherein said bit vector further comprises at least one bit that represents a non-alphanumeric symbol.

47. The method of claim 46 wherein said non-alphanumeric symbol indicates an email address.

48. The method of claim 46 wherein said non-alphanumeric symbol indicates a mobile number.

49. The method of claim 46 wherein said non-alphanumeric symbol indicates a wired number.

50. The method of claim 46 wherein said non-alphanumeric symbol indicates a paper-mail address.

51. The method of claim 46 wherein said non-alphanumeric symbol indicates a cost ranking.

52. The method of claim 46 wherein said non-alphanumeric symbol indicates a quality ranking.

53. The method of claim 46 wherein said non-alphanumeric symbol indicates a cuisine.

54. A method for incremental keyword search, the method comprising:
step for submitting an input keyword string comprising one or more words comprising one or more symbols; and
step for receiving in response to said submitting at least one candidate keyword string having a bit vector that matches a bit vector of said input keyword string.

55. The method of claim 54, further comprising step for preempting said method after a predetermined amount of time.

56. The method of claim 55 wherein said predetermined amount of time is two seconds.

57. A method for incremental keyword search, the method comprising:
step for receiving an input keyword string comprising one or more words comprising one or more symbols;
step for creating a bit vector based at least in part on said input keyword string;
step for comparing said bit vector with one or more other bit vectors representing at least one candidate keyword string to create a set of matching bit vectors;
step for applying a conventional keyword matching algorithm to said at least one candidate keyword string represented by said set of matching bit vectors; and
step for presenting any matching candidate keyword strings.

58. The method of claim 57, further comprising step for preempting said method after a predetermined amount of time.

59. The method of claim 58 wherein said predetermined amount of time is two seconds.

60. The method of claim 57 wherein said comparing is independent of the order of keyword prefixes in keyword strings.

61. A method for creating a keyword string database, the method comprising:
step for determining one or more candidate keyword strings to store in said database;
step for creating one or more bit vectors based at least in part on said one or more candidate keyword strings, said bit vector having a bit position for each symbol in an alphabet and having bits set for bit positions corresponding to at least one symbol representing the first symbol of a word in said one or more candidate keyword strings, said one or more bit vectors for use in comparing an input bit vector with said one or more bit vectors to indicate whether an input keyword string represented by said input bit vector matches said one or more candidate keyword strings; and
step for storing said one or more bit vectors and a reference to said one or more candidate keyword strings in said database.

62. A method for incremental keyword search, the method comprising:
step for submitting an input keyword string comprising one or more words comprising one or more symbols; and
step for receiving in response to said submitting at least one candidate keyword string where the first symbol of at least one word in each of said at least one candidate keyword string matches the first symbol of the corresponding word in said input keyword string.

63. The method of claim 62, further comprising step for preempting said method after a predetermined amount of time.

64. The method of claim 63 wherein said predetermined amount of time is two seconds.

65. A method for incremental keyword search, the method comprising:
step for receiving an input keyword string comprising one or more words comprising one or more symbols;
step for creating a bit vector based at least in part on said input keyword string, said bit vector having a bit position for each symbol in an alphabet and having bits set for positions corresponding to at least one symbol representing the first symbol of a word in said input keyword string;
step for comparing said bit vector with one or more other bit vectors representing at least one candidate keyword string to create a set of matching bit vectors;
step for applying a conventional keyword matching algorithm to said at least one candidate keyword string represented by said set of matching bit vectors; and
step for presenting any matching candidate keyword strings.

66. The method of claim 65, further comprising step for preempting said method after a predetermined amount of time.

67. The method of claim 66 wherein said predetermined amount of time is two seconds.

68. The method of claim 65 wherein said comparing is independent of the order of keyword prefixes in keyword strings.

69. A method for comparing keyword strings, the method comprising:
step for determining a relative frequency of use for at least one symbol in a language;
step for assigning a statistical weighting to said at least one symbol based at least in part on a relative frequency of use of said at least one symbol;
step for assigning each of said at least one symbol to one of a plurality of groups; and
step for comparing a first keyword string and a second keyword string based at least in part on whether at least one symbol of said first keyword string is assigned to the same group as at least one corresponding symbol of said second keyword string.

70. The method of claim 69 wherein said step for assigning further comprises step for assigning each of said at least one symbol to one of a plurality of groups so as to minimize the difference between the sums of statistical weightings for symbols comprising each group in said plurality of groups.

71. The method of claim 69 wherein said relative frequency of use comprises the relative frequency of use of symbols in the first character of words in said language.

72. A method for creating a keyword string database, the method comprising:
step for determining one or more candidate keyword strings to store in said database;
step for creating one or more bit vectors based at least in part on said one or more candidate keyword strings, each bit of said one or more bit vectors corresponding to one or more symbols in an alphabet, bits having a bit position corresponding to the first symbol of a word in said one or more candidate keyword strings being set, said one or more bit vectors for use in comparing an input bit vector with said one or more bit vectors to indicate whether an input keyword string represented by said input bit vector matches said one or more candidate keyword strings; and
step for storing said one or more bit vectors and a reference to said one or more candidate keyword strings in said database.

73. A method for incremental keyword search, the method comprising:
step for submitting an input keyword string comprising one or more words comprising one or more symbols, each symbol representing the first symbol of a word in a search string; and
step for receiving in response to said submitting at least one candidate keyword string where the first symbol of each word in each candidate keyword string is comprised by a group comprising said one or more symbols.

74. The method of claim 73, further comprising step for preempting said method after a predetermined amount of time.

75. The method of claim 74 wherein said predetermined amount of time is two seconds.

76. A method for incremental keyword search, the method comprising:
step for receiving an input keyword string comprising one or more words comprising one or more symbols, each symbol representing the first symbol of a word in a search string;
step for creating a bit vector based at least in part on said input keyword string, each bit corresponding to one or more symbols in an alphabet, bits having a bit position corresponding to said one or more symbols being set;
step for comparing said bit vector with one or more other bit vectors representing at least one candidate keyword string to create a set of matching bit vectors;
step for applying a conventional keyword matching algorithm to said at least one candidate keyword string represented by said set of matching bit vectors; and
step for presenting any matching candidate keyword strings.

77. The method of claim 76, further comprising step for preempting said method after a predetermined amount of time.

78. The method of claim 77 wherein said predetermined amount of time is two seconds.

79. The method of claim 76 wherein said comparing is independent of the order of keyword prefixes in keyword strings.

80. A method for creating a keyword string database, the method comprising:
step for determining one or more candidate keyword strings to store in said database;
step for creating one or more bit vectors based at least in part on said one or more candidate keyword strings, each bit of said one or bit vector corresponding to one or more symbols in an alphabet, bits having a bit position corresponding to a symbol of a prefix of a word in said one or more candidate keyword strings being set, said one or more bit vectors for use in comparing an input bit vector with said one or more bit vectors to indicate whether an input keyword string represented by said input bit vector matches said one or more candidate keyword strings; and
step for storing said one or more bit vectors and a reference to said one or more candidate keyword strings in said database.

81. A method for incremental keyword search, the method comprising:
step for submitting an input keyword string comprising one or more words comprising one or more symbols; and
step for receiving in response to said submitting at least one candidate keyword string where a prefix of a word of a matching candidate keyword string comprises at least one symbol that belongs to the same symbol group as the corresponding symbol of the corresponding word in said input keyword string.

82. The method of claim 81, further comprising step for preempting said method after a predetermined amount of time.

83. The method of claim 82 wherein said predetermined amount of time is two seconds.

84. A method for incremental keyword search, the method comprising:
step for receiving an input keyword string comprising one or more words comprising one or more symbols;
step for creating a bit vector based at least in part on said input keyword string, each bit corresponding to one or more symbols in an alphabet, bits having a bit position corresponding to a prefix of a word in said one or more symbols being set;
step for comparing said bit vector with one or more other bit vectors representing at least one candidate keyword string to create a set of matching bit vectors;
step for applying a conventional keyword matching algorithm to said at least one candidate keyword string represented by said set of matching bit vectors; and
step for presenting any matching candidate keyword strings.

85. The method of claim 84, further comprising step for preempting said method after a predetermined amount of time.

86. The method of claim 85 wherein said predetermined amount of time is two seconds.

87. The method of claim 84 wherein said comparing is independent of the order of keyword prefixes in keyword strings.

88. A method for incremental keyword search, the method comprising:
step for receiving an input keyword string comprising one or more words comprising one or more symbols, each symbol representing the first symbol of a word in a search string;
step for receiving a hierarchy, elements of said hierarchy comprising intermediate nodes and leaf nodes representing one or more keyword strings comprising one or more words comprising one or more symbols;
step for creating hierarchy bit vectors corresponding to said one or more keyword strings in said hierarchy;
step for searching said hierarchy bit vectors for a match with said input keyword string, said step for searching comprising, for each of said elements of said hierarchy:
step for saving said input keyword string;
step for applying a logical “AND” operation to the bit vector of the element and a bit vector based at least in part on said input keyword string, said applying producing a result;
step for if said result is nonzero, removing from said input keyword string any words in said input keyword string that are prefixes of words in the element;
step for if said input keyword string is empty, adding said element to a list of matched items; and
step for restoring said input keyword string; and
step for rendering said list of matched items.

89. A program storage device readable by a machine, embodying a program of instructions executable by the machine to perform a method for creating a keyword string database, the method comprising:
determining one or more candidate keyword strings to store in said database;
creating one or more bit vectors based at least in part on said one or more candidate keyword strings, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

90. The program storage device of claim 89 wherein said bit vector further comprises at least one bit that represents a non-alphanumeric symbol.

91. The program storage device of claim 90 wherein said non-alphanumeric symbol indicates an email address.

92. The program storage device of claim 90 wherein said non-alphanumeric symbol indicates a mobile number.

93. The program storage device of claim 90 wherein said non-alphanumeric symbol indicates a wired number.

94. The program storage device of claim 90 wherein said non-alphanumeric symbol indicates a paper-mail address.

95. The program storage device of claim 90 wherein said non-alphanumeric symbol indicates a cost ranking.

96. The program storage device of claim 90 wherein said non-alphanumeric symbol indicates a quality ranking.

97. The program storage device of claim 90 wherein said non-alphanumeric symbol indicates a cuisine.

98. A program storage device readable by a machine, embodying a program of instructions executable by the machine to perform a method for incremental keyword search, the method comprising:
submitting an input keyword string comprising one or more words comprising one or more symbols; and
receiving in response to said submitting at least one candidate keyword string having a bit vector that matches a bit vector of said input keyword string.

99. The program storage device of claim 98 wherein said method further comprises preempting said method after a predetermined amount of time.

100. The program storage device of claim 99 wherein said predetermined amount of time is two seconds.

101. A program storage device readable by a machine, embodying a program of instructions executable by the machine to perform a method for incremental keyword search, the method comprising:
receiving an input keyword string comprising one or more words comprising one or more symbols;
creating a bit vector based at least in part on said input keyword string;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

102. The program storage device of claim 101 wherein said method further comprises preempting said method after a predetermined amount of time.

103. The program storage device of claim 102 wherein said predetermined amount of time is two seconds.

104. The program storage device of claim 101 wherein said comparing is independent of the order of keyword prefixes in keyword strings.

105. A program storage device readable by a machine, embodying a program of instructions executable by the machine to perform a method for creating a keyword string database, the method comprising:
determining one or more candidate keyword strings to store in said database;
creating one or more bit vectors based at least in part on said one or more candidate keyword strings, said bit vector having a bit position for each symbol in an alphabet and having bits set for bit positions corresponding to at least one symbol representing the first symbol of a word in said one or more candidate keyword strings, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

106. A program storage device readable by a machine, embodying a program of instructions executable by the machine to perform a method for incremental keyword search, the method comprising:
submitting an input keyword string comprising one or more words comprising one or more symbols; and
receiving in response to said submitting at least one candidate keyword string where the first symbol of at least one word in each of said at least one candidate keyword string matches the first symbol of the corresponding word in said input keyword string.

107. The program storage device of claim 106 wherein said method further comprises preempting said method after a predetermined amount of time.

108. The program storage device of claim 107 wherein said predetermined amount of time is two seconds.

109. A program storage device readable by a machine, embodying a program of instructions executable by the machine to perform a method for incremental keyword search, the method comprising:
receiving an input keyword string comprising one or more words comprising one or more symbols;
creating a bit vector based at least in part on said input keyword string, said bit vector having a bit position for each symbol in an alphabet and having bits set for positions corresponding to at least one symbol representing the first symbol of a word in said input keyword string;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

110. The program storage device of claim 109 wherein said method further comprises preempting said method after a predetermined amount of time.

111. The program storage device of claim 110 wherein said predetermined amount of time is two seconds.

112. The program storage device of claim 109 wherein said comparing is independent of the order of keyword prefixes in keyword strings.

113. A program storage device readable by a machine, embodying a program of instructions executable by the machine to perform a method for comparing keyword strings, the method comprising:
determining a relative frequency of use for at least one symbol in a language;
assigning a statistical weighting to said at least one symbol based at least in part on a relative frequency of use of said at least one symbol;
assigning each of said at least one symbol to one of a plurality of groups; and
comparing a first keyword string and a second keyword string based at least in part on whether at least one symbol of said first keyword string is assigned to the same group as at least one corresponding symbol of said second keyword string.

114. The program storage device of claim 113 wherein said assigning further comprises assigning each of said at least one symbol to one of a plurality of groups so as to minimize the difference between the sums of statistical weightings for symbols comprising each group in said plurality of groups.

115. The program storage device of claim 113 wherein said relative frequency of use comprises the relative frequency of use of symbols in the first character of words in said language.

116. A program storage device readable by a machine, embodying a program of instructions executable by the machine to perform a method for creating a keyword string database, the method comprising:
determining one or more candidate keyword strings to store in said database;
creating one or more bit vectors based at least in part on said one or more candidate keyword strings, each bit of said one or more bit vectors corresponding to one or more symbols in an alphabet, bits having a bit position corresponding to the first symbol of a word in said one or more candidate keyword strings being set, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

117. A program storage device readable by a machine, embodying a program of instructions executable by the machine to perform a method for incremental keyword search, the method comprising:
submitting an input keyword string comprising one or more words comprising one or more symbols, each symbol representing the first symbol of a word in a search string; and
receiving in response to said submitting at least one candidate keyword string where the first symbol of each word in each candidate keyword string is comprised by a group comprising said one or more symbols.

118. The program storage device of claim 117 wherein said method further comprises preempting said method after a predetermined amount of time.

119. The program storage device of claim 118 wherein said predetermined amount of time is two seconds.

120. A program storage device readable by a machine, embodying a program of instructions executable by the machine to perform a method for incremental keyword search, the method comprising:
receiving an input keyword string comprising one or more words comprising one or more symbols, each symbol representing the first symbol of a word in a search string;
creating a bit vector based at least in part on said input keyword string, each bit corresponding to one or more symbols in an alphabet, bits having a bit position corresponding to said one or more symbols being set;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

121. The program storage device of claim 120 wherein said method further comprises preempting said method after a predetermined amount of time.

122. The program storage device of claim 121 wherein said predetermined amount of time is two seconds.

123. The program storage device of claim 120 wherein said comparing is independent of the order of keyword prefixes in keyword strings.

124. A program storage device readable by a machine, embodying a program of instructions executable by the machine to perform a method for creating a keyword string database, the method comprising:
determining one or more candidate keyword strings to store in said database;
creating one or more bit vectors based at least in part on said one or more candidate keyword strings, each bit of said one or bit vector corresponding to one or more symbols in an alphabet, bits having a bit position corresponding to a symbol of a prefix of a word in said one or more candidate keyword strings being set, said one or more bit vectors for use in comparing an input bit vector with said one or more bit vectors to indicate whether an input keyword string represented by said input bit vector matches said one or more candidate keyword strings; and
storing said one or more bit vectors and a reference to said one or more candidate keyword strings in said database.

125. A program storage device readable by a machine, embodying a program of instructions executable by the machine to perform a method for incremental keyword search, the method comprising:
submitting an input keyword string comprising one or more words comprising one or more symbols; and
receiving in response to said submitting at least one candidate keyword string where a prefix of a word of a matching candidate keyword string comprises at least one symbol that belongs to the same symbol group as the corresponding symbol of the corresponding word in said input keyword string.

126. The program storage device of claim 125 wherein said method further comprises preempting said method after a predetermined amount of time.

127. The program storage device of claim 126 wherein said predetermined amount of time is two seconds.

128. A program storage device readable by a machine, embodying a program of instructions executable by the machine to perform a method for incremental keyword search, the method comprising:
receiving an input keyword string comprising one or more words comprising one or more symbols;
creating a bit vector based at least in part on said input keyword string, each bit corresponding to one or more symbols in an alphabet, bits having a bit position corresponding to a prefix of a word in said one or more symbols being set;
comparing said bit vector with one or more other bit vectors representing at least one candidate keyword string to create a set of matching bit vectors;
applying a conventional keyword matching algorithm to said at least one candidate keyword string represented by said set of matching bit vectors; and
presenting any matching candidate keyword strings.

129. The program storage device of claim 128 wherein said method further comprises preempting said method after a predetermined amount of time.

130. The program storage device of claim 129 wherein said predetermined amount of time is two seconds.

131. The program storage device of claim 128 wherein said comparing is independent of the order of keyword prefixes in keyword strings.

132. A program storage device readable by a machine, embodying a program of instructions executable by the machine to perform a method for incremental keyword search, the method comprising:
receiving an input keyword string comprising one or more words comprising one or more symbols, each symbol representing the first symbol of a word in a search string;
receiving a hierarchy, elements of said hierarchy comprising intermediate nodes and leaf nodes representing one or more keyword strings comprising one or more words comprising one or more symbols;
creating hierarchy bit vectors corresponding to said one or more keyword strings in said hierarchy;
searching said hierarchy bit vectors for a match with said input keyword string, said searching comprising, for each of said elements of said hierarchy:
saving said input keyword string;
applying a logical “AND” operation to the bit vector of the element and a bit vector based at least in part on said input keyword string, said applying producing a result;
if said result is nonzero, removing from said input keyword string any words in said input keyword string that are prefixes of words in the element;
if said input keyword string is empty, adding said element to a list of matched items; and
restoring said input keyword string; and
rendering said list of matched items.

133. An apparatus for creating a keyword string database, the apparatus comprising:
means for determining one or more candidate keyword strings to store in said database;
means for creating one or more bit vectors based at least in part on said one or more candidate keyword strings, said one or more bit vectors for use in comparing an input bit vector with said one or more bit vectors to indicate whether an input keyword string represented by said input bit vector matches said one or more candidate keyword strings; and
means for storing said one or more bit vectors and a reference to said one or more candidate keyword strings in said database.

134. The apparatus of claim 133 wherein said bit vector further comprises at least one bit that represents a non-alphanumeric symbol.

135. The apparatus of claim 134 wherein said non-alphanumeric symbol indicates an email address.

136. The apparatus of claim 134 wherein said non-alphanumeric symbol indicates a mobile number.

137. The apparatus of claim 134 wherein said non-alphanumeric symbol indicates a wired number.

138. The apparatus of claim 134 wherein said non-alphanumeric symbol indicates a paper-mail address.

139. The apparatus of claim 134 wherein said non-alphanumeric symbol indicates a cost ranking.

140. The apparatus of claim 134 wherein said non-alphanumeric symbol indicates a quality ranking.

141. The apparatus of claim 134 wherein said non-alphanumeric symbol indicates a cuisine.

142. An apparatus for incremental keyword search, the apparatus comprising:
means for receiving an input keyword string comprising one or more words comprising one or more symbols;
means for creating a bit vector based at least in part on said input keyword string;
means for comparing said bit vector with one or more other bit vectors representing at least one candidate keyword string to create a set of matching bit vectors;
means for applying a conventional keyword matching algorithm to said at least one candidate keyword string represented by said set of matching bit vectors; and
means for presenting any matching candidate keyword strings.

143. The apparatus of claim 142, further comprising means for preempting said receiving, said creating, said comparing, said applying and said presenting after a predetermined amount of time.

144. The apparatus of claim 143 wherein said predetermined amount of time is two seconds.

145. The apparatus of claim 142 wherein said comparing is independent of the order of keyword prefixes in keyword strings.

146. An apparatus for creating a keyword string database, the apparatus comprising:
means for determining one or more candidate keyword strings to store in said database;
means for creating one or more bit vectors based at least in part on said one or more candidate keyword strings, said bit vector having a bit position for each symbol in an alphabet and having bits set for bit positions corresponding to at least one symbol representing the first symbol of a word in said one or more candidate keyword strings, said one or more bit vectors for use in comparing an input bit vector with said one or more bit vectors to indicate whether an input keyword string represented by said input bit vector matches said one or more candidate keyword strings; and
means for storing said one or more bit vectors and a reference to said one or more candidate keyword strings in said database.

147. An apparatus for incremental keyword search, the apparatus comprising:
means for receiving an input keyword string comprising one or more words comprising one or more symbols;
means for creating a bit vector based at least in part on said input keyword string, said bit vector having a bit position for each symbol in an alphabet and having bits set for positions corresponding to at least one symbol representing the first symbol of a word in said input keyword string;
means for comparing said bit vector with one or more other bit vectors representing at least one candidate keyword string to create a set of matching bit vectors;
means for applying a conventional keyword matching algorithm to said at least one candidate keyword string represented by said set of matching bit vectors; and
means for presenting any matching candidate keyword strings.

148. The apparatus of claim 147, further comprising means for preempting said receiving, said creating, said comparing, said applying and said presenting after a predetermined amount of time.

149. The apparatus of claim 148 wherein said predetermined amount of time is two seconds.

150. The apparatus of claim 147 wherein said comparing is independent of the order of keyword prefixes in keyword strings.

151. An apparatus for comparing keyword strings, the apparatus comprising:
means for determining a relative frequency of use for at least one symbol in a language;
means for assigning a statistical weighting to said at least one symbol based at least in part on a relative frequency of use of said at least one symbol;
means for assigning each of said at least one symbol to one of a plurality of groups; and
means for comparing a first keyword string and a second keyword string based at least in part on whether at least one symbol of said first keyword string is assigned to the same group as at least one corresponding symbol of said second keyword string.

152. The apparatus of claim 151 wherein said means for assigning further comprises means for assigning each of said at least one symbol to one of a plurality of groups so as to minimize the difference between the sums of statistical weightings for symbols comprising each group in said plurality of groups.

153. The apparatus of claim 151 wherein said relative frequency of use comprises the relative frequency of use of symbols in the first character of words in said language.

154. An apparatus for creating a keyword string database, the apparatus comprising:
means for determining one or more candidate keyword strings to store in said database;
means for creating one or more bit vectors based at least in part on said one or more candidate keyword strings, each bit of said one or more bit vectors corresponding to one or more symbols in an alphabet, bits having a bit position corresponding to the first symbol of a word in said one or more candidate keyword strings being set, said one or more bit vectors for use in comparing an input bit vector with said one or more bit vectors to indicate whether an input keyword string represented by said input bit vector matches said one or more candidate keyword strings; and
means for storing said one or more bit vectors and a reference to said one or more candidate keyword strings in said database.

155. An apparatus for incremental keyword search, the apparatus comprising:
means for receiving an input keyword string comprising one or more words comprising one or more symbols, each symbol representing the first symbol of a word in a search string;
means for creating a bit vector based at least in part on said input keyword string, each bit corresponding to one or more symbols in an alphabet, bits having a bit position corresponding to said one or more symbols being set;
means for comparing said bit vector with one or more other bit vectors representing at least one candidate keyword string to create a set of matching bit vectors;
means for applying a conventional keyword matching algorithm to said at least one candidate keyword string represented by said set of matching bit vectors; and
means for presenting any matching candidate keyword strings.

156. The apparatus of claim 155, further comprising means for preempting said receiving, said creating, said comparing, said applying and said presenting after a predetermined amount of time.

157. The apparatus of claim 156 wherein said predetermined amount of time is two seconds.

158. The apparatus of claim 155 wherein said comparing is independent of the order of keyword prefixes in keyword strings.

159. An apparatus for creating a keyword string database, the apparatus comprising:
means for determining one or more candidate keyword strings to store in said database;
means for creating one or more bit vectors based at least in part on said one or more candidate keyword strings, each bit of said one or bit vector corresponding to one or more symbols in an alphabet, bits having a bit position corresponding to a symbol of a prefix of a word in said one or more candidate keyword strings being set, said one or more bit vectors for use in comparing an input bit vector with said one or more bit vectors to indicate whether an input keyword string represented by said input bit vector matches said one or more candidate keyword strings; and
means for storing said one or more bit vectors and a reference to said one or more candidate keyword strings in said database.

160. An apparatus for incremental keyword search, the apparatus comprising:
means for receiving an input keyword string comprising one or more words comprising one or more symbols;
means for creating a bit vector based at least in part on said input keyword string, each bit corresponding to one or more symbols in an alphabet, bits having a bit position corresponding to a prefix of a word in said one or more symbols being set;
means for comparing said bit vector with one or more other bit vectors representing at least one candidate keyword string to create a set of matching bit vectors;
means for applying a conventional keyword matching algorithm to said at least one candidate keyword string represented by said set of matching bit vectors; and
means for presenting any matching candidate keyword strings.

161. The apparatus of claim 160, further comprising means for preempting said said receiving, said creating, said comparing, said applying and said presenting after a predetermined amount of time.

162. The apparatus of claim 161 wherein said predetermined amount of time is two seconds.

163. The apparatus of claim 160 wherein said comparing is independent of the order of keyword prefixes in keyword strings.

164. An apparatus for incremental keyword search, the apparatus comprising:
means for receiving an input keyword string comprising one or more words comprising one or more symbols, each symbol representing the first symbol of a word in a search string;
means for receiving a hierarchy, elements of said hierarchy comprising intermediate nodes and leaf nodes representing one or more keyword strings comprising one or more words comprising one or more symbols;
means for creating hierarchy bit vectors corresponding to said one or more keyword strings in said hierarchy;
means for searching said hierarchy bit vectors for a match with said input keyword string, said means for searching comprising, for each of said elements of said hierarchy:
means for saving said input keyword string;
means for applying a logical “AND” operation to the bit vector of the element and a bit vector based at least in part on said input keyword string, said applying producing a result;
means for if said result is nonzero, removing from said input keyword string any words in said input keyword string that are prefixes of words in the element;
means for if said input keyword string is empty, adding said element to a list of matched items; and
means for restoring said input keyword string; and
means for rendering said list of matched items.

165. An apparatus for creating a keyword string database, the apparatus comprising:
a memory for storing said keyword string database; and
a processor configured to:
determine one or more candidate keyword strings to store in said database;
create one or more bit vectors based at least in part on said one or more candidate keyword strings, said one or more bit vectors for use in comparing an input bit vector with said one or more bit vectors to indicate whether an input keyword string represented by said input bit vector matches said one or more candidate keyword strings; and
store said one or more bit vectors and a reference to said one or more candidate keyword strings in said database.

166. The apparatus of claim 165 wherein said bit vector further comprises at least one bit that represents a non-alphanumeric symbol.

167. The apparatus of claim 166 wherein said non-alphanumeric symbol indicates an email address.

168. The apparatus of claim 166 wherein said non-alphanumeric symbol indicates a mobile number.

169. The apparatus of claim 166 wherein said non-alphanumeric symbol indicates a wired number.

170. The apparatus of claim 166 wherein said non-alphanumeric symbol indicates a paper-mail address.

171. The apparatus of claim 166 wherein said non-alphanumeric symbol indicates a cost ranking.

172. The apparatus of claim 166 wherein said non-alphanumeric symbol indicates a quality ranking.

173. The apparatus of claim 166 wherein said non-alphanumeric symbol indicates a cuisine.

174. An apparatus for incremental keyword search, the apparatus comprising:
a user interface configured to receive an input keyword string comprising one or more words comprising one or more symbols, said user interface further configured to present any matching keyword strings; and
a search engine in communication with said user interface and configured to:
create a bit vector based at least in part on said input keyword string;
compare said bit vector with one or more other bit vectors representing at least one candidate keyword string to create a set of matching bit vectors; and
apply a conventional keyword matching algorithm to said at least one candidate keyword string represented by said set of matching bit vectors.

175. The apparatus of claim 174 wherein said apparatus is further configured to preempt said search enging after a predetermined amount of time.

176. The apparatus of claim 175 wherein said predetermined amount of time is two seconds.

177. The apparatus of claim 174 wherein said apparatus is further configured to compare said bit vector independent of the order of keyword prefixes in keyword strings.

178. An apparatus for creating a keyword string database, the apparatus comprising:
a memory for storing said keyword string database; and
a processor configured to:
determine one or more candidate keyword strings to store in said database;
create one or more bit vectors based at least in part on said one or more candidate keyword strings, said bit vector having a bit position for each symbol in an alphabet and having bits set for bit positions corresponding to at least one symbol representing the first symbol of a word in said one or more candidate keyword strings, said one or more bit vectors for use in comparing an input bit vector with said one or more bit vectors to indicate whether an input keyword string represented by said input bit vector matches said one or more candidate keyword strings; and
store said one or more bit vectors and a reference to said one or more candidate keyword strings in said database.

179. An apparatus for incremental keyword search, the apparatus comprising:
a user interface configured to receive an input keyword string comprising one or more words comprising one or more symbols, said user interface further configured to present any matching keyword strings; and
a search engine in communication with said user interface and configured to:
create a bit vector based at least in part on said input keyword string, said bit vector having a bit position for each symbol in an alphabet and having bits set for positions corresponding to at least one symbol representing the first symbol of a word in said input keyword string;
compare said bit vector with one or more other bit vectors representing at least one candidate keyword string to create a set of matching bit vectors; and
apply a conventional keyword matching algorithm to said at least one candidate keyword string represented by said set of matching bit vectors.

180. The apparatus of claim 179 wherein said apparatus is further configured to preempt said search enging after a predetermined amount of time.

181. The apparatus of claim 180 wherein said predetermined amount of time is two seconds.

182. The apparatus of claim 179 wherein said apparatus is further configured to compare said bit vector independent of the order of keyword prefixes in keyword strings.

183. An apparatus for comparing keyword strings, the apparatus comprising:
a memory for storing at least one relative frequency of use for at least one symbol in a language; and
a processor configured to:
determine a relative frequency of use for at least one symbol in a language;
assign a statistical weighting to said at least one symbol based at least in part on a relative frequency of use of said at least one symbol;
assign each of said at least one symbol to one of a plurality of groups; and
compare a first keyword string and a second keyword string based at least in part on whether at least one symbol of said first keyword string is assigned to the same group as at least one corresponding symbol of said second keyword string.

184. The apparatus of claim 183 wherein said processor is further configured to assign each of said at least one symbol to one of a plurality of groups so as to minimize the difference between the sums of statistical weightings for symbols comprising each group in said plurality of groups.

185. The apparatus of claim 183 wherein said relative frequency of use comprises the relative frequency of use of symbols in the first character of words in said language.

186. An apparatus for creating a keyword string database, the apparatus comprising:
a memory for storing said keyword string database; and
a processor configured to:
determine one or more candidate keyword strings to store in said database;
create one or more bit vectors based at least in part on said one or more candidate keyword strings, each bit of said one or more bit vectors corresponding to one or more symbols in an alphabet, bits having a bit position corresponding to the first symbol of a word in said one or more candidate keyword strings being set, said one or more bit vectors for use in comparing an input bit vector with said one or more bit vectors to indicate whether an input keyword string represented by said input bit vector matches said one or more candidate keyword strings; and
store said one or more bit vectors and a reference to said one or more candidate keyword strings in said database.

187. An apparatus for incremental keyword search, the apparatus comprising:
a user interface configured to receive an input keyword string comprising one or more words comprising one or more symbols, each symbol representing the first symbol of a word in a search string, said user interface further configured to present any matching keyword strings; and
a search engine in communication with said user interface and configured to:
create a bit vector based at least in part on said input keyword string, each bit corresponding to one or more symbols in an alphabet, bits having a bit position corresponding to said one or more symbols being set;
compare said bit vector with one or more other bit vectors representing at least one candidate keyword string to create a set of matching bit vectors; and
apply a conventional keyword matching algorithm to said at least one candidate keyword string represented by said set of matching bit vectors.

188. The apparatus of claim 187 wherein said apparatus is further configured to preempt said search enging after a predetermined amount of time.

189. The apparatus of claim 188 wherein said predetermined amount of time is two seconds.

190. The apparatus of claim 187 wherein said apparatus is further configured to compare said bit vector independent of the order of keyword prefixes in keyword strings.

191. An apparatus for creating a keyword string database, the apparatus comprising:
a memory for storing said keyword string database; and
a processor configured to:
determine one or more candidate keyword strings to store in said database;
create one or more bit vectors based at least in part on said one or more candidate keyword strings, each bit of said one or bit vector corresponding to one or more symbols in an alphabet, bits having a bit position corresponding to a symbol of a prefix of a word in said one or more candidate keyword strings being set, said one or more bit vectors for use in comparing an input bit vector with said one or more bit vectors to indicate whether an input keyword string represented by said input bit vector matches said one or more candidate keyword strings; and
store said one or more bit vectors and a reference to said one or more candidate keyword strings in said database.

192. An apparatus for incremental keyword search, the apparatus comprising:
a user interface configured to receive an input keyword string comprising one or more words comprising one or more symbols, said user interface further configured to present any matching keyword strings; and
a search engine in communication with said user interface and configured to:
create a bit vector based at least in part on said input keyword string, each bit corresponding to one or more symbols in an alphabet, bits having a bit position corresponding to a prefix of a word in said one or more symbols being set;
compare said bit vector with one or more other bit vectors representing at least one candidate keyword string to create a set of matching bit vectors; and
apply a conventional keyword matching algorithm to said at least one candidate keyword string represented by said set of matching bit vectors.

193. The apparatus of claim 192 wherein said apparatus is further configured to preempt said search enging after a predetermined amount of time.

194. The apparatus of claim 193 wherein said predetermined amount of time is two seconds.

195. The apparatus of claim 192 wherein said apparatus is further configured to compare said bit vector independent of the order of keyword prefixes in keyword strings.

196. An apparatus for incremental keyword search, the apparatus comprising:
a user interface configured to receive an input keyword string comprising one or more words comprising one or more symbols, said user interface further configured to present any matching keyword strings; and
a search engine in communication with said user interface and configured to:
receive an input keyword string comprising one or more words comprising one or more symbols, each symbol representing the first symbol of a word in a search string;
receive a hierarchy, elements of said hierarchy comprising intermediate nodes and leaf nodes representing one or more keyword strings comprising one or more words comprising one or more symbols;
create hierarchy bit vectors corresponding to said one or more keyword strings in said hierarchy;
search said hierarchy bit vectors for a match with said input keyword string, said apparatus further configured to, for each of said elements of said hierarchy:
save said input keyword string;
apply a logical “AND” operation to the bit vector of the element and a bit vector based at least in part on said input keyword string, said applying producing a result;
if said result is nonzero, remove from said input keyword string any words in said input keyword string that are prefixes of words in the element;
if said input keyword string is empty, add said element to a list of matched items; and
restoring said input keyword string; and
render said list of matched items; and
apply a conventional keyword matching algorithm to said at least one keyword string represented by one or more element in said list of matched items.

197. A method for comparing keyword strings, the method comprising:
assigning each of at least one symbol in a language to one of a plurality of groups; and
comparing a first keyword string and a second keyword string based at least in part on whether at least one symbol of said first keyword string is assigned to the same group as at least one corresponding symbol of said second keyword string.

198. The method of claim 197 wherein said plurality of groups corresponds with a telephone keyboard symbol grouping.

199. A method for comparing keyword strings, the method comprising:
step for assigning each of at least one symbol in a language to one of a plurality of groups; and
step for comparing a first keyword string and a second keyword string based at least in part on whether at least one symbol of said first keyword string is assigned to the same group as at least one corresponding symbol of said second keyword string.

200. The method of claim 199 wherein said plurality of groups corresponds with a telephone keyboard symbol grouping.

201. A program storage device readable by a machine, embodying a program of instructions executable by the machine to perform a method for comparing keyword strings, the method comprising:
assigning each of at least one symbol in a language to one of a plurality of groups; and
comparing a first keyword string and a second keyword string based at least in part on whether at least one symbol of said first keyword string is assigned to the same group as at least one corresponding symbol of said second keyword string.

202. The program storage device of claim 201 wherein said plurality of groups corresponds with a telephone keyboard symbol grouping.

203. An apparatus for comparing keyword strings, the method comprising:
means for assigning each of at least one symbol in a language to one of a plurality of groups; and
means for comparing a first keyword string and a second keyword string based at least in part on whether at least one symbol of said first keyword string is assigned to the same group as at least one corresponding symbol of said second keyword string.

204. The apparatus of claim 203 wherein said plurality of groups corresponds with a telephone keyboard symbol grouping.

205. An apparatus for comparing keyword strings, the apparatus comprising:
a memory for storing said keyword strings; and
a processor configured to:
assign each of at least one symbol in a language to one of a plurality of groups; and
compare a first keyword string and a second keyword string based at least in part on whether at least one symbol of said first keyword string is assigned to the same group as at least one corresponding symbol of said second keyword string.

206. The apparatus of claim 205 wherein said plurality of groups corresponds with a telephone keyboard symbol grouping.
